(19) United States
(12) Patent Application Publication
(10) Pub. No.: US 2026/0109074 A1
(43) Pub. Date: Apr. 23, 2026

(54) VENEER PROCESSING SYSTEM, DEWATERING METHOD FOR VENEER, AND PROCESSING METHOD FOR VENEER

(71) Applicant: Meinan Machinery Works, Inc., Obu-shi, Aichi (JP)

(72) Inventor: Shinichi SAKAMOTO, Obu-shi, Aichi (JP)

(21) Appl. No.: 19/168,714

(22) PCT Filed: Mar. 11, 2024
(86) PCT No.: PCT/JP2024/009362

§ 371 Date: Sep. 24, 2025

(30) Foreign Application Priority Data
May 2, 2023 (JP) 2023-076027

(51) Int. Cl. B27D 1/02; F26B 3/20; F26B 5/14

(52) U.S. Cl. CPC B27D 1/02; F26B 3/20; F26B 5/14

(57) ABSTRACT

A dehydration system 1a includes: a first clamping member 101 including a first heating plate 101a capable of generating heat; a second clamping member 102 including a second heating plate 102b capable of generating heat; a drive unit 4 capable of causing a pressing mechanism to press at least one of the first clamping member 101 and the second clamping member 102; a heating unit 3 capable of heating the first heating plate 101a and the second heating plate 102a; and a control unit 2a that, during the dehydration process, controls the drive unit 4 so that the veneer is pressed by the first clamping member 101 and the second clamping member 102 and controls the heating unit 3 so that the temperature of the first heating plate 101a is lower than the temperature of the second heating plate 102a.

By way of this preliminary amendment, claims 1, 3-6, 9, and 10 have been amended for conformity with the allowed claims of JP application no. 2024-541110, claim 2 has been canceled without prejudice, and new claim 11 has been added. An English translation of the international patent application, as filed, is submitted herewith. The amendments noted above are made with respect to that translation. No new matter has been added.

The Commissioner is hereby authorized to refund any overpayment and charge any deficiency in the amount paid in connection with this paper or any additional fees which may be required during the pendency of this application under 37 CFR 1.16 or 1.17 to Deposit Account No. 50-2455.

### TECHNICAL FIELD

The present invention relates to a dehydration system for dehydrating a moisture-containing veneer, a veneer processing system including the dehydration system, a veneer dehydration method using the dehydration system, and a veneer processing method using the veneer drying system.

### BACKGROUND ART

Generally, a veneer is a natural product. For this reason, even within the same veneer, there are differences in tissue structure, moisture content, and shrinkage rate due to drying depending on a part, and warping or bending occurs when drying the veneer up to a moisture content sufficient for practical use. In addition, the moisture content of the veneer differs depending on a part. For this reason, when drying the veneer using hot air or the like, tissues with a relatively low moisture content dry first, and dry excessively by the time tissues with a relatively high moisture content dry sufficiently, which further contributes to warping, bending, and a decrease in the strength of the veneer.

When veneers with large warping or bending are stacked and bonded together to manufacture a plywood product or the like, a portion bulged due to warping or bending is caught in the manufacturing machine to cause clogging. In addition, when a veneer is crushed during clogging, the machine should be stopped for an extended period of time to remove the crushed veneer. In addition, excessive drying causes numerous cracks in the veneer structure. Since this reduces the strength, the veneer structure has often been broken or crushed inside the manufacturing machine or during transport to the manufacturing machine.

In addition, the degree of shrinkage of veneer differs depending on its location due to anisotropy of expansion and contraction caused by factors such as density and the direction of wood fibers. For this reason, even when the veneer is dried in a state of being clamped and fixed using heating plate drying and the drying is completed in a state in which the veneer has a high degree of straightness with no bending and the like, there has been a problem that the veneer later absorbs moisture from the atmosphere to cause dimensional changes that vary depending on the location, resulting in deformation such as warping and bending.

Conventionally, in order to reduce the warping or bending of the veneer and the difference in drying speed, it was considered desirable to use clamp drying with a heating plate, which could control the shape of the veneer while performing drying. In this case, it was possible to perform drying with the good smoothness of the veneer surface.

In addition, by performing a dehydration process before the drying process, the differences in moisture content within the same veneer can be reduced. Therefore, by including the dehydration processing, it is possible to obtain a veneer with less warping or bending even after drying.

Regarding this dehydration process, JP7007787B (Patent Literature 1) proposes the following veneer dehydration method. That is, stacked veneers, which are stacked such that the fiber directions of the veneers cross each other, are carried between a pair of upper and lower fixed plates arranged so as to face each other. Then, the stacked veneers are compressed by applying pressure from both sides of the stacking direction to dehydrate moisture content of the veneers. The above-described veneer dehydration method has been proposed. According to the dehydration method in Patent Literature 1, cracking due to dimensional changes resulting from mechanical compression and dehydration of the veneer can be suppressed by pressing veneers having different fiber directions against each other so that the expansion of the veneers in a direction perpendicular to the fiber direction is restricted by the friction between the veneers.

### CITATION LIST

### Patent Literature

PTL 1: JP7007787B

### SUMMARY OF INVENTION

### Technical Problem

However, when the dehydration process is performed before the drying process according to the dehydration method described in Patent Literature 1, the following problem arises. That is, in Patent Literature 1, the stacked veneers are pressed in the thickness direction of the veneers by a press using flat plates at room temperature, so that the veneers are compressed at a high compression rate. Then, since the veneers are compressed at a high compression rate, the wood structure is destroyed. For this reason, there has been a problem that the strength of the veneer is reduced and the thickness dimension is not fully recovered after the pressure is released, resulting in insufficient thickness. Such a decrease in strength and insufficient thickness of the veneer can lead to insufficient strength or poor thickness when a product such as plywood is manufactured from the veneer. When the compression rate during the dehydration process is reduced to solve this problem, the wood is not sufficiently dehydrated. Therefore, the original purpose of the dehydration process is not achieved.

The invention has been made in view of the above, and it is an object of the invention to realize sufficient dehydration while suppressing the occurrence of a decrease in strength and an insufficient thickness of the veneers.

### Solution to Problem

In order to solve the above-mentioned problems, a dehydration apparatus according to the invention includes: a first clamping member including a first heating plate that is a heating plate capable of generating heat; a second clamping member including a second heating plate that is a heating plate capable of generating heat; a drive unit capable of causing a pressing mechanism to press at least one of the first clamping member and the second clamping member; a heating unit capable of heating the first heating plate and the second heating plate; and a control unit that, during the dehydration process, controls the drive unit so that the veneer is pressed by the first clamping member and the second clamping member and controls the heating unit so that a temperature of the first heating plate is lower than a temperature of the second heating plate.

### Advantageous Effects of Invention

According to the invention configured as described above, the veneer is heated by a pair of clamping members, and at the same time, the veneer is pressed between the pair of clamping members to perform the dehydration process. Since the veneer is heated during the dehydration process as described above, the flexibility and elasticity of the fibers of the veneer are improved, so that the veneer can be pressed in a state in which the elasticity range of the fibers is expanded. This improvement in the flexibility and elasticity of the fibers of the veneer can suppress fiber breakage that may occur when the veneer is pressed. Therefore, it is possible to suppress a decrease in the strength of the veneer. In addition, since the expansion of the elasticity range of the fibers of the veneer can provide a large restoring force that allows the thickness of the veneer to be fully restored when released from pressing, it is possible to suppress the occurrence of insufficient thickness in the veneer.

In addition, according to the invention, during the dehydration process, the temperature of the heating plate of one of the pair of clamping members for clamping the veneer is set to be lower than the temperature of the heating plate of the other clamping member. Therefore, during the dehydration process, a consistent moisture flow from the surface on the high temperature side to the surface on the low temperature side is formed within the veneer, while the moisture is pushed out and discharged from the surface on the low temperature side. Therefore, it is possible to efficiently discharge the moisture within the veneer. Then, due to the efficient discharge of the moisture, sufficient dehydration with little residual moisture is realized.

That is, according to the invention, with regard to the dehydration of a veneer, it is possible to realize sufficient dehydration while suppressing the occurrence of a decrease in strength and an insufficient thickness of the veneer.

### BRIEF DESCRIPTION OF DRAWINGS

FIG. 1 is a diagram showing an example of the configuration of a veneer processing system according to Embodiment 1.

FIG. 2 is a diagram showing an example of a veneer.

FIG. 3 is a perspective view of a dehydration apparatus according to Embodiment 1.

FIG. 4 is a diagram of the dehydration apparatus when viewed from the arrow V10 in FIG. 1.

FIG. 5 is a perspective view of a first clamping member.

FIG. 6 is a perspective view of an interposed plate.

FIG. 7 (A) in FIG. 7 is a diagram of the interposed plate when viewed from the arrow F1 in FIG. 6, and (B) in FIG. 7 is an enlarged view of part A in (A).

FIG. 8 (A) in FIG. 8 is a diagram of the interposed plate when viewed from the arrow B1 in FIG. 6, and (B) in FIG. 8 is an enlarged view of part B in (A).

FIG. 9 is a perspective view of a second clamping member.

FIG. 10 is a diagram showing a dehydration apparatus in a restricted state.

FIG. 11 is a perspective view of a drying apparatus according to Embodiment 1.

FIG. 12 is a diagram of the drying apparatus when viewed from the arrow V15 in FIG. 11.

FIG. 13 is a perspective view of a drying side clamping member.

FIG. 14 is a perspective view of a drying side interposed plate.

FIG. 15 (A) in FIG. 15 is a diagram of the drying side interposed plate when viewed from the arrow F2 in FIG. 14, and (B) in FIG. 15 is an enlarged view of part C in (A).

FIG. 16 (A) in FIG. 16 is a diagram of the drying side interposed plate when viewed from the arrow B2 in FIG. 14, and (B) in FIG. 16 is an enlarged view of part D in (A).

FIG. 17 is a perspective view of a second drying side clamping member.

FIG. 18 is a diagram showing a drying apparatus in a held state.

FIG. 19 is a flowchart showing an operation example of a control apparatus according to Embodiment 1.

FIG. 20 is a diagram showing an example of the configuration of a veneer processing system according to Embodiment 2.

FIG. 21 is a perspective view of a dehydration apparatus according to Embodiment 2.

FIG. 22 is a diagram of the dehydration apparatus when viewed from the arrow V20 in FIG. 21.

FIG. 23 is a perspective view of a high-temperature clamping member.

FIG. 24 is a perspective view of a low-temperature clamping member.

FIG. 25 is a diagram showing a dehydration apparatus in a restricted state.

FIG. 26 is a perspective view of a drying apparatus according to Embodiment 2.

FIG. 27 is a diagram of the dehydration apparatus when viewed from the arrow V25 in FIG. 26.

FIG. 28 is a perspective view of a high-temperature clamping member.

FIG. 29 is a perspective view of a low-temperature clamping member.

FIG. 30 is a diagram showing a dehydration apparatus in a restricted state.

FIG. 31 is a flowchart showing an operation example of a control apparatus according to Embodiment 2.

FIG. 32 is a perspective view of a dehydration apparatus according to Embodiment 3.

FIG. 33 is a diagram of the dehydration apparatus when viewed from the arrow V30 in FIG. 32.

FIG. 34 is a perspective view of a second clamping member.

FIG. 35 is a perspective view of a dehydration apparatus according to Embodiment 4.

FIG. 36 is a diagram of the dehydration apparatus when viewed from the arrow V40 in FIG. 35.

FIG. 37 is a perspective view of a high-temperature clamping member.

FIG. 38 is a perspective view of a dehydration apparatus according to Embodiment 5.

FIG. 39 is a diagram of the dehydration apparatus when viewed from the arrow V50 in FIG. 38.

FIG. 40 is a cross-sectional view taken along the line X-X in FIG. 39.

FIG. 41 is a diagram showing a feeder.

FIG. 42 is a diagram showing the feeder.

FIG. 43 is a perspective view of a dehydration apparatus according to Embodiment 6.

FIG. 44 is a diagram of the dehydration apparatus when viewed from the arrow V60 in FIG. 43.

FIG. 45 is a diagram showing a feeder.

FIG. 46 is a diagram showing the feeder.

### DESCRIPTION OF EMBODIMENTS

### Embodiment 1

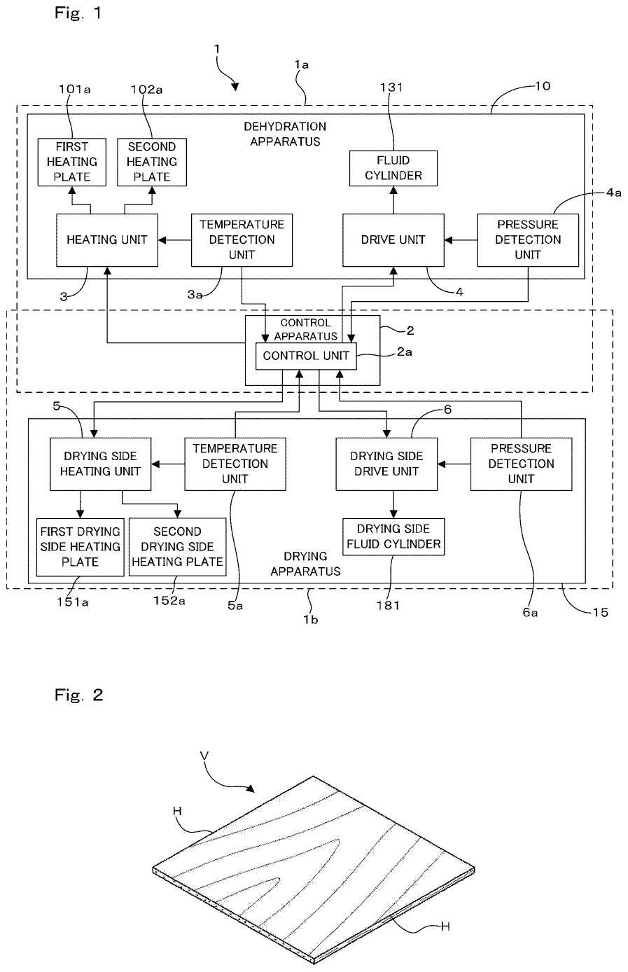

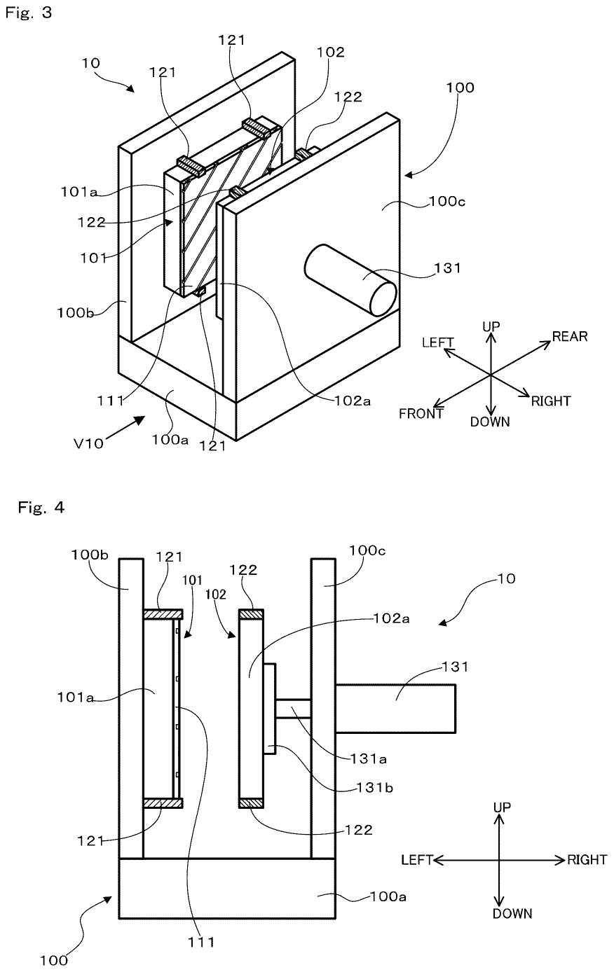

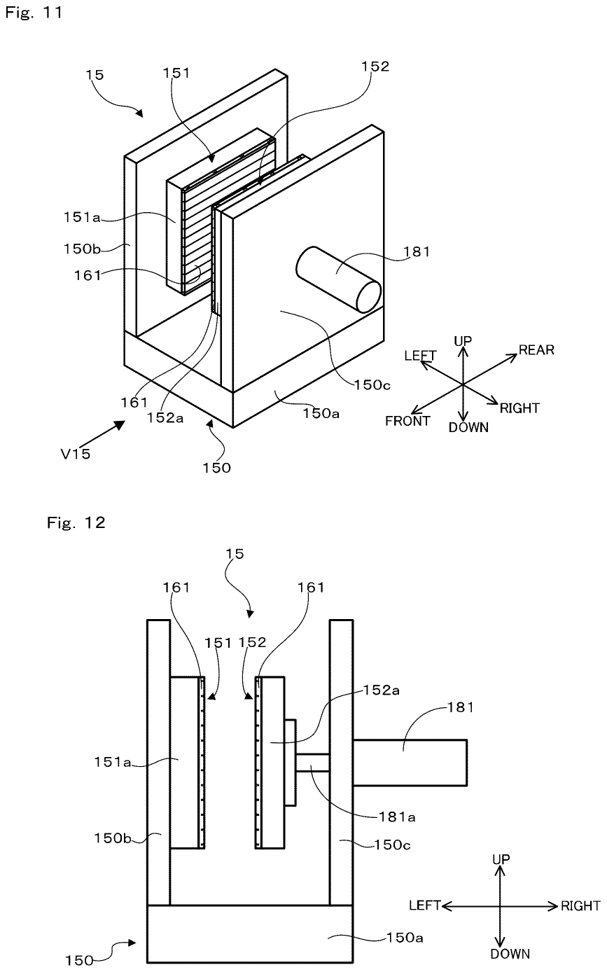

FIG. 1 is a block diagram showing an example of the configuration of a veneer processing system 1 according to the present embodiment. The veneer processing system 1 is a system for dehydrating and drying a veneer V. As shown in FIG. 1, the veneer processing system 1 includes a dehydration apparatus 10 (see also FIG. 3) for dehydrating a raw veneer GV, a drying apparatus 15 (see also FIG. 11) for drying a dehydrated veneer DV dehydrated by the dehydration apparatus 10, and a control apparatus 2 for controlling the dehydration apparatus 10 and the drying apparatus 15. The dehydration apparatus 10 and the control apparatus 2 form a dehydration system 1a. The drying apparatus 15 and the control apparatus 2 form a drying system 1b. Note that, for the convenience of explanation, in the present embodiment and other embodiments described later, a process related to dehydration performed by the dehydration apparatus 10 is referred to as a “dehydration process”, a process related to drying performed by the drying apparatus 15 is referred to as a “drying process”, and a combination of the dehydration process by the dehydration apparatus 10 and the drying process by the drying apparatus 15 is referred to as a “series process”.

In the present embodiment, the veneer V is a plate-shaped wood material obtained by peeling a log in a spiral manner using a veneer lathe. FIG. 2 is a diagram schematically showing an example of the veneer V. The veneer V has a rectangular shape when viewed from a direction perpendicular to the main surface. Then, the fiber direction of the veneer V is generally parallel to one of two pairs of sides that define the outer periphery of the veneer V. The fiber direction of the veneer V shown in FIG. 2 extends approximately parallel to a pair of sides H. Note that the raw veneer GV is a convenient expression for the veneer V before the dehydration process by the dehydration apparatus 10 is performed. In addition, the dehydrated veneer DV is a convenient expression for the veneer V before the drying process by the drying apparatus 15 is performed after the dehydration process by the dehydration apparatus 10 is performed. Note that the veneer V shown in the present embodiment is an example, and all plate-shaped wood materials to be dried by the veneer processing system 1 can be “veneer”.

The control apparatus 2 is a computer having at least a function of controlling the dehydration apparatus 10 and the drying apparatus 15. As shown in FIG. 1, the control apparatus 2 includes a control unit 2a as a functional block. The control unit 2a includes a CPU (processor), a primary storage device, and an auxiliary storage device. The CPU includes a control mechanism, an arithmetic mechanism, a register, and a cache memory. However, the configuration of the CPU is not limited to this, and any configuration that can realize the necessary arithmetic processing function/information processing function may be used. The primary storage device includes a volatile memory such as a DRAM, and temporarily stores data that is directly read and written by the CPU. The auxiliary storage device includes a nonvolatile memory such as a ROM, and stores various kinds of data in a nonvolatile manner. The control unit 2a performs various processes by the CPU reading out programs stored in the auxiliary storage device into the primary storage device and executing the programs. However, the configuration of the control unit 2a is not limited to the configuration exemplified in the present embodiment, and may be any configuration that allows various processes to be performed by cooperation between hardware and software.

### <Configuration of the Dehydration Apparatus 10>

Next, the configuration of the dehydration apparatus 10 will be described. FIG. 3 is a perspective view of the dehydration apparatus 10 according to this modification example. FIG. 4 is a diagram of the dehydration apparatus 10 when viewed toward the arrow V10 in FIG. 3. In the following description, the front-rear direction, the up-down direction, and the left-right direction based on the dehydration apparatus 10 are defined as shown in FIGS. 3 and 4. The up-down direction matches the vertical direction when the dehydration apparatus 10 is installed in a normal operating state. However, the up-down direction based on the dehydration apparatus 10 does not have to completely match the vertical direction. That is, the dehydration apparatus 10 may be installed in a state in which the up-down direction based on the dehydration apparatus 10 is slightly tilted with respect to the vertical direction. The same is true for the drying apparatus 15 and for a dehydration apparatus and a drying apparatus according to other embodiments.

As shown in FIGS. 3 and 4, the dehydration apparatus 10 includes a frame 100. The frame 100 includes a base 100a that functions as a foundation, a support wall 100b standing on the left part of the top surface of the base 100a, and a support wall 100c standing on the right part of the top surface. In addition, the dehydration apparatus 10 includes a pair of first clamping member 101 and second clamping member 102 that are arranged so as to face each other between the support wall 100b and the support wall 100c.

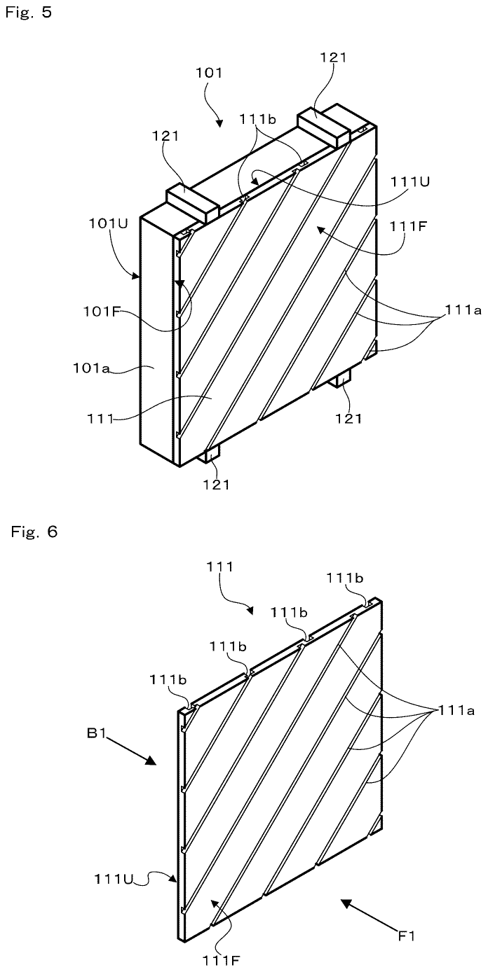

FIG. 5 is a perspective view of the first clamping member 101. As shown in FIGS. 3 to 5, the first clamping member 101 includes a first heating plate 101a having a rectangular parallelepiped shape. The first heating plate 101a has a back surface 101U (FIG. 5), which is a smooth surface. The back surface 101U of the first heating plate 101a is fixed to a predetermined position on the inner surface of the support wall 100b. Since the back surface 101U of the first heating plate 101a is fixed to the inner surface of the support wall 100b, the first clamping member 101 is firmly fixed to the support wall 100b. In the first heating plate 101a, a front surface 101F (FIG. 5), which is a smooth surface, is formed on a side opposite to the back surface 101U.

The first heating plate 101a is a member capable of generating heat. As shown in FIG. 1, the dehydration apparatus 10 includes a heating unit 3. The heating unit 3 can heat the first heating plate 101a to the set target temperature under the control of the control unit 2a. Hereinafter, the target temperature set for the first heating plate 101a will be referred to as a “first target temperature”. The method for heating the first heating plate 101a by the heating unit 3 is a steam heating method. That is, a steam path is provided in the first heating plate 101a, and saturated steam is supplied to the steam path by the heating unit 3 under the control of the control unit 2a, thereby heating the first heating plate 101a.

The heating unit 3 includes a control board for controlling each part of the heating unit 3, a mechanism for supplying saturated steam to the steam path, and other elements necessary for heating the first heating plate 101a to the first target temperature. In addition, as shown in FIG. 1, the dehydration apparatus 10 includes a temperature detection unit 3a that detects the temperature of the first heating plate 101a based on the detection result of a temperature detection sensor provided corresponding to the first heating plate 101a and outputs a signal indicating the temperature to the heating unit 3 and the control unit 2a. The heating unit 3 adjusts the temperature of the first heating plate 101a based on the input from the temperature detection unit 3a under the control of the control unit 2a. Note that the temperature of the first heating plate 101a is adjusted by a known means. The above matters regarding the heating unit 3 are the same for the second heating plate 102a described later, the same for a drying side heating unit 5 described later, and the same for other embodiments.

Note that the heating method of the heating unit 3 is not limited to the steam heating method. For example, a heating method may be used in which an electric heater is provided on the first heating plate 101a and the first heating plate 101a is heated by driving the electric heater using the heating unit 3. In addition, for example, a heating method may be used in which a flow path for heat transfer oil is provided in the first heating plate 101a and the first heating plate 101a is heated by the heating unit 3 supplying heat transfer oil to the flow path. In this case, the heat transfer oil may be heated by any method.

As shown in FIG. 5, two restricting members 121 are provided on the top surface of the first heating plate 101a at a distance therebetween in the front-rear direction. Similarly, two restricting members 121 are provided on the bottom surface of the first heating plate 101a at a distance therebetween in the front-rear direction. The function of the restricting member 121 will be described later.

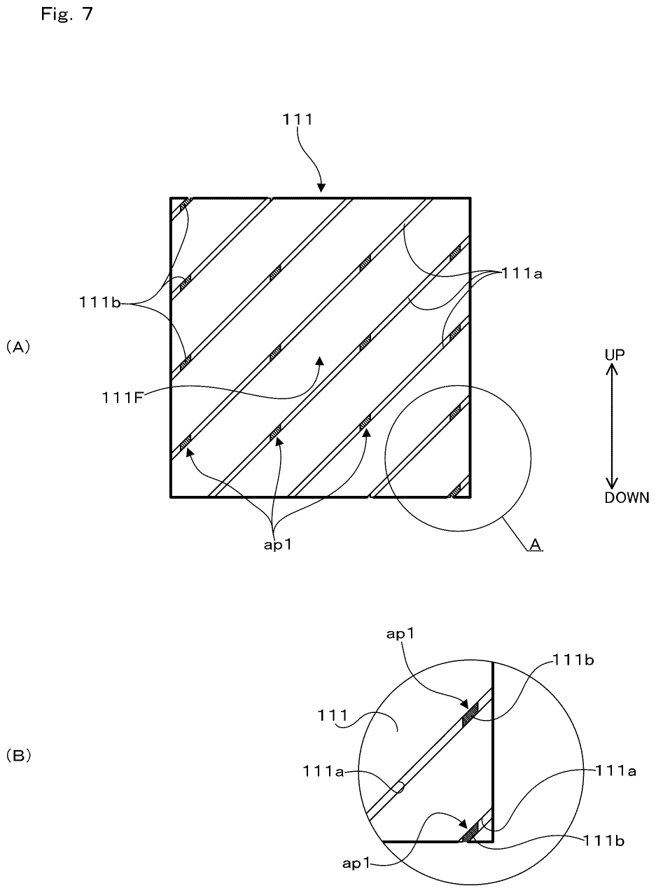

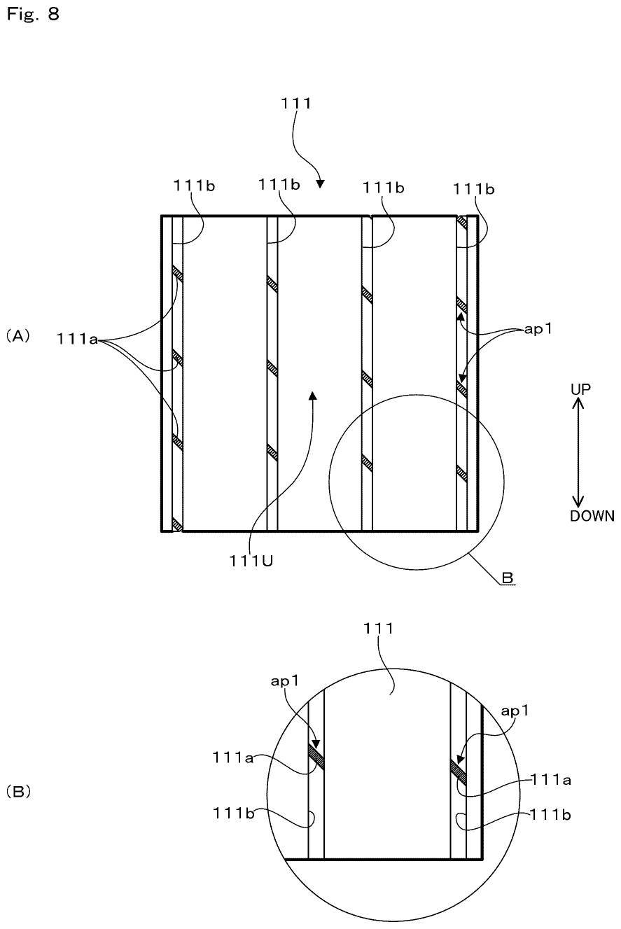

As shown in FIGS. 3 to 5, in the first clamping member 101, an interposed plate 111, which is interposed between the first heating plate 101a and the raw veneer GV during the dehydration process, is attached to the front surface 101F of the first heating plate 101a. FIG. 6 is a perspective view of the interposed plate 111. (A) in FIG. 7 is a diagram of the interposed plate 111 when viewed toward the arrow F1 in FIG. 6. (B) in FIG. 7 is an enlarged view of part A in (A). (A) in FIG. 8 is a diagram of the interposed plate 111 when viewed toward the arrow B1 in FIG. 6. (B) in FIG. 8 is an enlarged view of part B in (A).

The interposed plate 111 is formed of a material (for example, metal) having necessary rigidity and thermal conductivity. The same is true for a drying side interposed plate 161 described later and for other embodiments. As shown in FIGS. 6 to 8, the interposed plate 111 has a back surface 111U (FIGS. 6 and 8) in contact with the front surface 101F of the first heating plate 101a and a front surface 111F (see FIGS. 6 and 7) on a side opposite to the back surface 111U. As will be apparent later, the front surface 111F is a surface that is in contact with the raw veneer GV during the dehydration process.

As shown in FIGS. 6 and 7, a plurality of (eight) interposed plate front grooves 111a (grooves) extending obliquely with respect to the up-down direction are formed on the front surface 111F of the interposed plate 111. The interposed plate front groove 111a is a groove (notch) having a fixed width and a fixed depth. In the present embodiment, each of the interposed plate front grooves 111a is formed at an angle of approximately 45° with respect to the up-down direction. Both ends of the interposed plate front groove 111a reach sides that define the outer periphery of the front surface 111F of the interposed plate 111. The interposed plate front grooves 111a are formed so as to be arranged at equal distances on the front surface 111F of the interposed plate 111.

On the other hand, as shown in FIG. 8, a plurality of (four) interposed plate back grooves 111b (grooves) extending in the up-down direction are formed on the back surface 111U of the interposed plate 111. The interposed plate back groove 111b is a groove (notch) having a fixed width and a fixed depth. The upper end of the interposed plate back groove 111b reaches the upper side of the back surface 111U of the interposed plate 111. The lower end of the interposed plate back groove 111b reaches the lower side of the back surface 111U of the interposed plate 111. The interposed plate back grooves 111b are formed so as to be arranged at equal distances on the back surface 111U of the interposed plate 111.

As shown in FIG. 7 (particularly (B) in FIG. 7) and FIG. 8 (particularly (B) in FIG. 8), in the interposed plate 111, a through hole apl that penetrates the interposed plate 111 in the thickness direction is formed at a point where the interposed plate front groove 111a formed on the front surface 111F and the interposed plate back groove 111b formed on the back surface 111U cross each other. Here, each of the interposed plate front grooves 111a and each of the interposed plate back grooves 111b are deep enough that their groove portions are connected to each other at a point where the interposed plate front groove 111a and the interposed plate back groove 111b cross each other, thereby forming the through hole apl at each point.

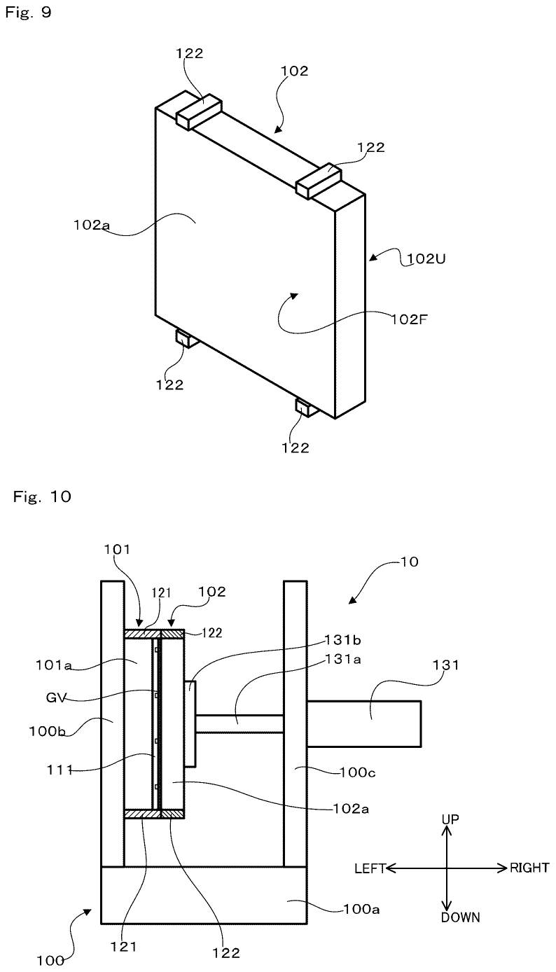

FIG. 9 is a perspective view of the second clamping member 102. As shown in FIG. 9, the second clamping member 102 includes a second heating plate 102a having a rectangular parallelepiped shape. The second heating plate 102a has a front surface 102F and a back surface 102U on a side opposite to the front surface 102F. Each of the front surface 102F and the back surface 102U is a smooth surface. The front surface 102F is a surface that is in contact with the raw veneer GV during the dehydration process. In the second clamping member 102, a member corresponding to the interposed plate 111 is not provided in the second heating plate 102a.

As shown in FIG. 1, the heating unit 3 can heat the second heating plate 102a to the set target temperature based on an input from the temperature detection unit 3a under the control of the control unit 2a. Hereinafter, the target temperature set for the second heating plate 102a will be referred to as a “second target temperature”. That is, the heating unit 3 can heat the first heating plate 101a and the second heating plate 102a to different target temperatures.

As shown in FIG. 9, two restricting members 122 are provided on the top surface of the second heating plate 102a at a distance therebetween in the front-rear direction. Similarly, two restricting members 122 are provided on the bottom surface of the second heating plate 102a at a distance therebetween in the front-rear direction. Each of the four restricting members 121 of the first clamping member 101 and each of the four restricting members 122 of the second clamping member 102 are arranged at positions facing each other in the left-right direction. During the dehydration process, the restricting members 121 and 122 come into contact with each other when the distance between the first clamping member 101 and the second clamping member 102 reaches a predetermined distance, thereby restricting these members from coming any closer to each other. Hereinafter, the state in which the approach of the opposing clamping members to each other is restricted by the restricting members will be referred to as a “restricted state”. FIG. 10 shows the dehydration apparatus 10 in a restricted state. That is, in FIG. 10, the restricting member 121 and the restricting member 122 come into contact with each other, so that the first clamping member 101 and the second clamping member 102 are restricted from coming any closer to each other.

As shown in FIGS. 3 and 4, a fluid cylinder 131 (pressing mechanism) is provided at a predetermined position on the support wall 100c. The fluid cylinder 131 is a hydraulic cylinder configured to be able to press the second clamping member 102. As shown in FIG. 4, the fluid cylinder 131 has a piston rod 131a that is movable in the left-right direction. The second clamping member 102 is fixed to the tip of the piston rod 131a through a flat plate-shaped fixing member 131b. More specifically, the fixing member 131b at the tip of the piston rod 131a is fixed to the back surface 102U of the second heating plate 102a of the second clamping member 102.

As shown in FIG. 1, the dehydration apparatus 10 includes a drive unit 4. The drive unit 4 drives the fluid cylinder 131 under the control of the control unit 2a, so that it is possible to press the second clamping member 102 by moving the piston rod 131a leftward. The drive unit 4 includes a control board for controlling each part of the drive unit 4, a hydraulic pump, an electric motor for driving the hydraulic pump, instruments, and other elements necessary for driving the fluid cylinder 131. The above matters regarding the drive unit 4 are the same for a drying side drive unit 6 and other embodiments described later. In addition, as shown in FIG. 1, the dehydration apparatus 10 includes a pressure detection unit 4a. When the raw veneer GV is clamped between the first clamping member 101 and the second clamping member 102, the pressure detection unit 4a detects the pressure applied to the raw veneer GV based on the detection result of a pressure detection sensor provided in the dehydration apparatus 10, and outputs a signal indicating the detected pressure to the drive unit 4 and the control unit 2a. Note that the state in which the veneer Vis clamped refers to a state in which the veneer V is interposed and supported by two clamping members regardless of the pressure applied to the veneer V.

In particular, the drive unit 4 can perform the following processes. That is, the drive unit 4 can “hold” the raw veneer GV with the first clamping member 101 and the second clamping member 102 under the control of the control unit 2a. Holding the raw veneer GV means applying a weak pressure to the second clamping member 102 using the fluid cylinder 131, thereby creating a state in which the raw veneer GV is clamped and supported between the first clamping member 101 and the second clamping member 102. The weak pressure means a pressure weak enough to maintain a state in which the raw veneer GV is supported by the frictional force acting between the first clamping member 101 and the second clamping member 102 and the raw veneer GV. Hereinafter, the state in which the veneer V is held by the two clamping members may be referred to as a “held state”. Note that the expression “hold” is an expression used for convenience to distinguish it from the expressions “clamp”and “press”.

In addition, the drive unit 4 can drive the fluid cylinder 131 from the held state under the control of the control unit 2a to apply further pressure to the raw veneer GV. In particular, under the control of the control unit 2a, the drive unit 4 can drive the fluid cylinder 131 so that the pressure applied to the raw veneer GV reaches the target pressure or a restricted state is reached. Hereinafter, the state in which the pressure applied to the raw veneer GV reaches the target pressure and the restricted state will be collectively referred to as a “pressed state”. FIG. 10 shows the dehydration apparatus 10 in the restricted state. The control unit 2a can maintain the pressed state for a predetermined period of time by driving the fluid cylinder 131 under the control of the control unit 2a.

<Configuration of the drying apparatus 15>

Next, the configuration of the drying apparatus 15 will be described. FIG. 11 is a perspective view of the drying apparatus 15 according to the present embodiment. FIG. 12 is a diagram of the drying apparatus 15 when viewed toward the arrow V15 in FIG. 11. In the following description, the front-rear direction, the up-down direction, and the left-right direction based on the drying apparatus 15 are defined as shown in FIGS. 11 and 12. The up-down direction matches the vertical direction when the drying apparatus 15 is installed in a normal operating state.

The configuration of the drying apparatus 15 is basically the same as that of the dehydration apparatus 10 except that a first drying side clamping member 151 is included instead of the first clamping member 101 of the dehydration apparatus 10 and a second drying side clamping member 152 is included instead of the second clamping member 102 of the dehydration apparatus 10. That is, the drying apparatus 15 includes a frame 150. The frame 150 includes a base 150a and a pair of support walls 150b and 150c standing on the base 150a. The first drying side clamping member 151 is fixed to the support wall 150b. The first drying side clamping member 151 will be described later. On the right side of the first drying side clamping member 151, the second drying side clamping member 152 is provided at a position facing the first drying side clamping member 151. The second drying side clamping member 152 will be described later. A drying side fluid cylinder 181 for pressing the second drying side clamping member 152 is provided on the support wall 150c. The drying side fluid cylinder 181 includes a piston rod 181a.

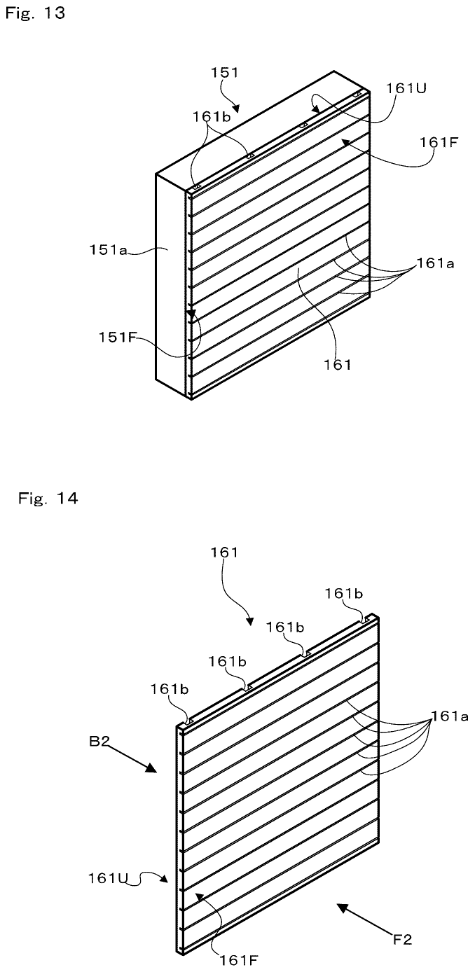

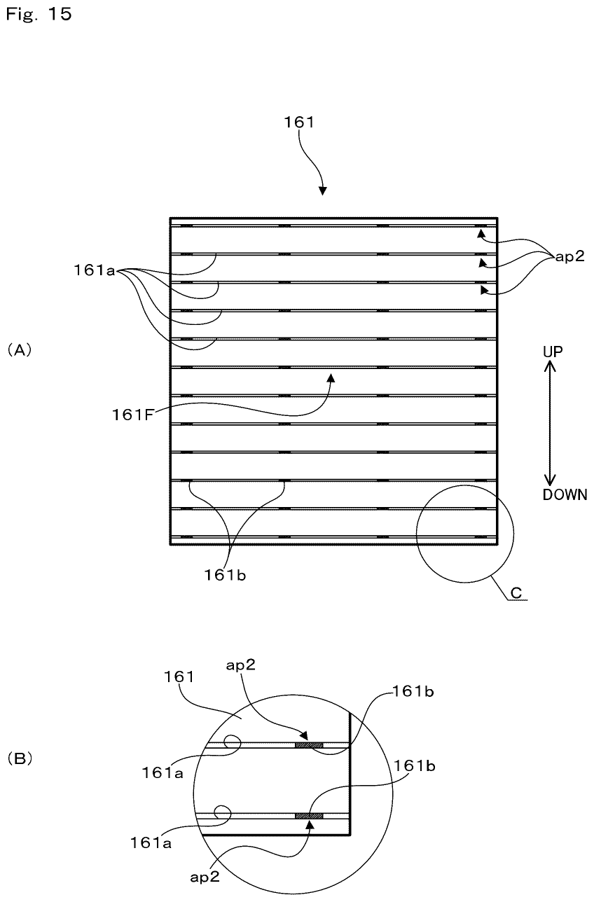

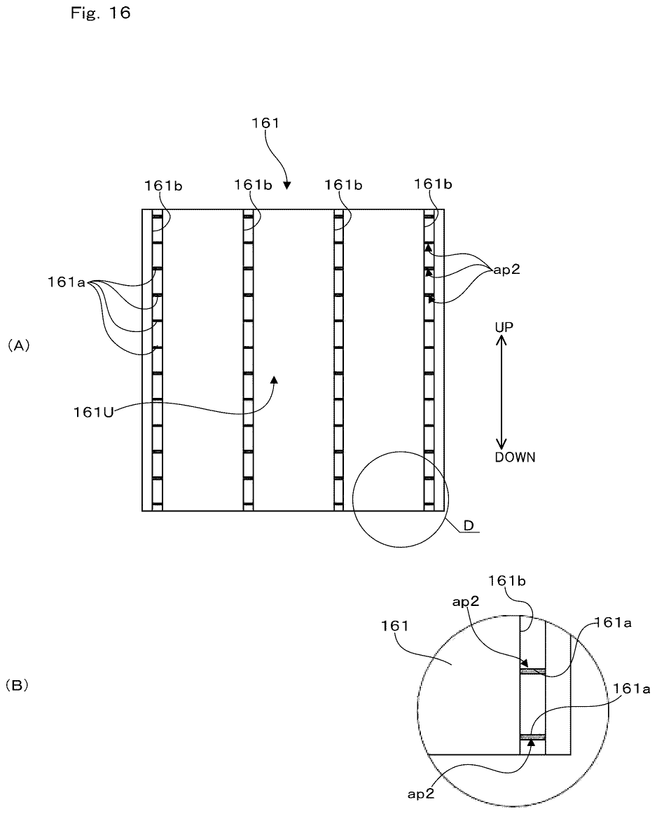

FIG. 13 is a perspective view of the first drying side clamping member 151. As shown in FIG. 13, the first drying side clamping member 151 includes a first drying side heating plate 151a, which is a heating plate having a rectangular parallelepiped shape. No member equivalent to the restricting member 121 is provided in the first drying side heating plate 151a. As shown in FIG. 13, the drying side interposed plate 161, which is interposed between the first drying side heating plate 151a and the dehydrated veneer DV during the drying process, is attached to a front surface 151F (FIG. 13) of the first heating plate 101a. FIG. 14 is a perspective view of the drying side interposed plate 161. (A) in FIG. 15 is a diagram of the drying side interposed plate 161 when viewed toward the arrow F2 in FIG. 14. (B) in FIG. 15 is an enlarged view of part C in (A). (A) in FIG. 16 is a diagram of the drying side interposed plate 161 when viewed toward the arrow B2 in FIG. 14. (B) in FIG. 16 is an enlarged view of part D in (A). As shown in FIGS. 14 to 16, the drying side interposed plate 161 has a back surface 161U in contact with the front surface 151F of the first drying side heating plate 151a and a front surface 161F on a side opposite to the back surface 161U. As will be apparent later, the front surface 161F is a surface that is in contact with the dehydrated veneer DV during the drying process.

As shown in FIG. 14, a plurality of (twelve) drying side interposed plate front grooves 161a (grooves) extending in a direction perpendicular to the up-down direction are formed on the front surface 161F of the drying side interposed plate 161. The drying side interposed plate front groove 161a is a groove (notch) having a fixed width and a fixed depth. Both ends of the drying side interposed plate front groove 161a reach sides (a pair of sides extending in the up-down direction) that define the outer periphery of the front surface 161F of the drying side interposed plate 161. The drying side interposed plate front grooves 161a are formed so as to be arranged at equal distances on the front surface 161F of the drying side interposed plate 161.

On the other hand, as shown in FIG. 16, a plurality of (four) drying side interposed plate back grooves 161b (grooves) extending in the up-down direction are formed on the back surface 161U of the drying side interposed plate 161. The drying side interposed plate back groove 161b is a groove (notch) having a fixed width and a fixed depth. Both ends of the drying side interposed plate back groove 161b reach sides (a pair of sides extending in the left-right direction) that define the outer periphery of the back surface 161U of the drying side interposed plate 161. The drying side interposed plate back grooves 161b are formed so as to be arranged at equal distances on the back surface 161U of the drying side interposed plate 161.

As shown in FIGS. 15 and 16 (particularly (B) in FIG. 15 and (B) in FIG. 16), in the drying side interposed plate 161, a through hole ap2 that penetrates the drying side interposed plate 161 in the thickness direction is formed at a point where the drying side interposed plate front groove 161a formed on the front surface 161F and the drying side interposed plate back groove 161b formed on the back surface 161B cross each other. Here, each of the drying side interposed plate front grooves 161a and each of the drying side interposed plate back grooves 161b are deep enough that their groove portions are connected to each other at a point where the drying side interposed plate front groove 161a and the drying side interposed plate back groove 161b cross each other, thereby forming the through hole ap2 at each point.

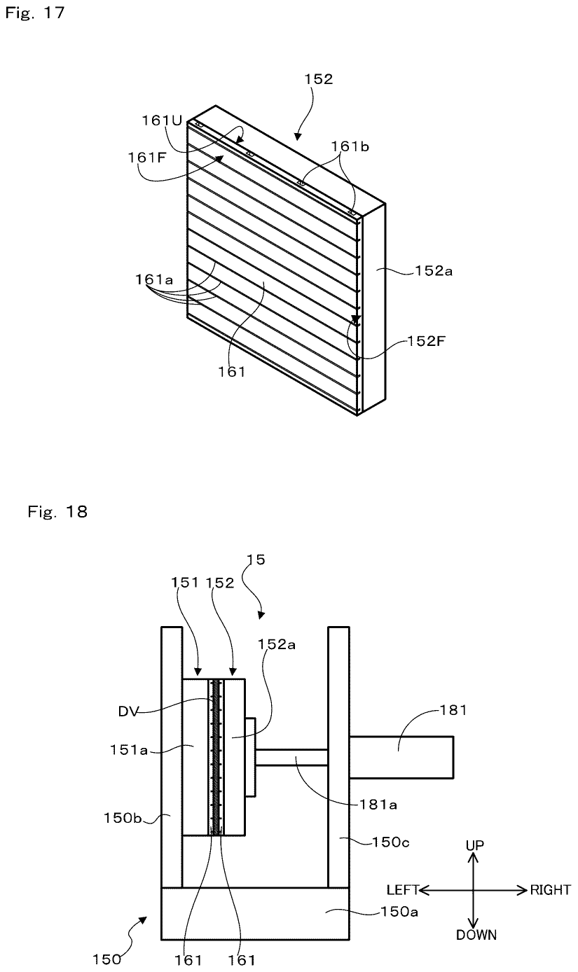

FIG. 17 is a perspective view of the second drying side clamping member 152. As shown in FIG. 17, the second drying side clamping member 152 includes a second drying side heating plate 152a, which is a heating plate having a rectangular parallelepiped shape. No member equivalent to the restricting member 122 is provided in the second drying side heating plate 152a. The drying side interposed plate 161, which is interposed between the second drying side heating plate 152a and the dehydrated veneer DV during the drying process, is attached to the front surface 152F of the second drying side heating plate 152a. The configuration of the drying side interposed plate 161 is the same as that described above.

As shown in FIG. 1, the drying apparatus 15 includes a drying side heating unit 5. In addition, the drying apparatus 15 includes a temperature detection unit 5a. The temperature detection unit 5a detects the temperature of the first drying side heating plate 151a based on the detection result of a temperature detection sensor provided corresponding to the first drying side heating plate 151a. The temperature detection unit 5a detects the temperature of the second drying side heating plate 152a based on the detection result of a temperature detection sensor provided corresponding to the second drying side heating plate 152a. The drying side heating unit 5 can heat the first drying side heating plate 151a to the set target temperature based on an input from the temperature detection unit 5a under the control of the control unit 2a. Hereinafter, the target temperature set for the first drying side heating plate 151a will be referred to as a “first drying side target temperature”. Similarly, the drying side heating unit 5 can heat the second drying side heating plate 152a to the set target temperature based on an input from the temperature detection unit 5a under the control of the control unit 2a. Hereinafter, the target temperature set for the second drying side heating plate 152a will be referred to as a “second drying side target temperature”.

As shown in FIG. 1, the drying apparatus 15 includes the drying side drive unit 6. The drying side drive unit 6 drives the drying side fluid cylinder 181 under the control of the control unit 2a, so that it is possible to press the second drying side clamping member 152 by moving the piston rod 181a leftward. In addition, as shown in FIG. 1, the drying apparatus 15 includes a pressure detection unit 6a that detects the pressure applied to the dehydrated veneer DV clamped by the clamping members based on the detection result of the pressure detection sensor. The drying side drive unit 6 drives the fluid cylinder 131 under the control of the control unit 2a, so that the raw veneer GV can be held by the first clamping member 101 and the second clamping member 102. FIG. 18 shows the drying apparatus 15 in a held state.

### <Operation of the Veneer Processing System 1>

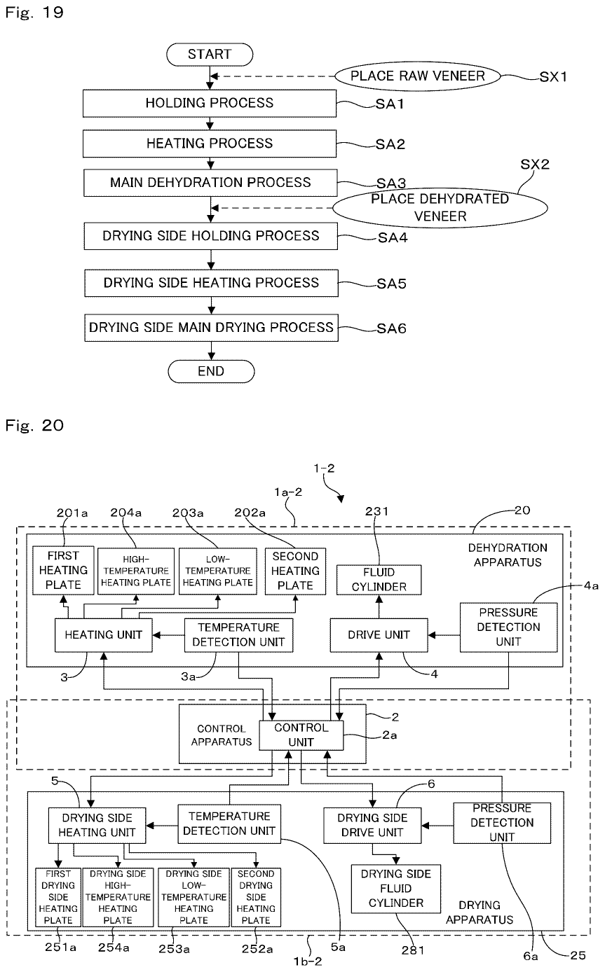

Next, focusing on a single piece of veneer V, the operation of the veneer processing system 1 when the veneer V is dehydrated as the raw veneer GV by the dehydration apparatus 10 and then dried as the dehydrated veneer DV by the drying apparatus 15 will be described using the flowchart of FIG. 19.

As shown in FIG. 19, first, the raw veneer GV is placed between the first clamping member 101 and the second clamping member 102 of the dehydration apparatus 10 (step SX1). At this time, the fiber direction of the raw veneer GV is aligned with the up-down direction (=vertical direction). This is because, due to the relationship with the strength of the raw veneer GV in the installation direction, the fiber direction of the raw veneer GV should be aligned with the vertical direction. Note that the processing of step SX1 may be performed automatically by a belt conveyor, an industrial robot, or other equipment. In addition, this process may be performed partially or entirely by human means. The following processes in steps SA1 to SA3 are performed for the dehydration apparatus 10.

Then, the control unit 2a performs a holding process (step SA1). More specifically, the control unit 2a controls the drive unit 4 to drive the fluid cylinder 131, so that the second clamping member 102 is pressed leftward to hold the raw veneer GV by the first clamping member 101 and the second clamping member 102. At this stage, a weak pressure sufficient to maintain the state of being clamped by the clamping members is applied to the raw veneer GV.

Then, the control unit 2a performs a heating process (step SA2). More specifically, in the present embodiment, a value to be set as a first target temperature for the first heating plate 101a of the first clamping member 101 (hereinafter, referred to as a “first set value TA1”) is determined in advance based on the following viewpoints.
(Viewpoint KX1) The first target temperature is set to be lower than the second target temperature for the second heating plate 102a of the second clamping member 102.
(Viewpoint KX2) In a predetermined temperature range, the fibers (structure) of the raw veneer GV become more flexible and elastic as the temperature increases, and the elasticity range expands. Based on this, the first target temperature is set to a temperature equal to or higher than a “temperature at which flexibility and elasticity necessary for the fibers of the raw veneer GV are obtained and the expansion of the necessary elasticity range is obtained due to heat generated by the first heating plate 101a during the main dehydration process (described later)”.
(Viewpoint KX3) The first target temperature is set to a “temperature at which the evaporation of moisture from the raw veneer GV due to heat generated by the first heating plate 101a does not occur during the main dehydration process (described later) (that is, a temperature sufficiently lower than the temperature at which the evaporation of moisture from the raw veneer GV due to heat generated by the first heating plate 101a starts).

Note that the “necessary flexibility and elasticity” and “expansion of the necessary elasticity range” in viewpoint KX2 will become clear later.

In the heating process of step SA2, the control unit 2a controls the heating unit 3 to heat the first heating plate 101a so that the temperature of the first heating plate 101a becomes the first set value TA1 (=the value set as the first target temperature).

In addition, a value to be set as a second target temperature for the second heating plate 102a of the second clamping member 102 (hereinafter, referred to as a “second set value TA2”) is determined in advance based on the following viewpoints.
(Viewpoint KY1) The second target temperature is set to be higher than the first target temperature for the first heating plate 101a of the first clamping member 101.
(Viewpoint KY2) The second target temperature is set to a temperature close to a “temperature at which the evaporation of moisture from the raw veneer GV due to heat generated by the second heating plate 102a starts during the main dehydration process”.

Note that, since the second target temperature is higher than the first target temperature, the heat generated by the second heating plate 102a naturally gives the fibers of the raw veneer GV the necessary flexibility, elasticity, and an expansion of the necessary elasticity range.

In the heating process of step SA2, the control unit 2a controls the heating unit 3 to heat the second heating plate 102a so that the temperature of the second heating plate 102a becomes the second set value TA2 (=the value set as the first target temperature).

Note that the timing for starting the heating process is not limited to the timing exemplified in the present embodiment. As an example, the heating process may be started before the holding process is started.

Then, the control unit 2a performs a main dehydration process (step SA3). More specifically, the control unit 2a controls the drive unit 4 to drive the fluid cylinder 131, so that the fluid cylinder 131 presses the second clamping member 102 to cause a pressed state. As described above, the pressed state is either a state in which the pressure applied to the raw veneer GV reaches a target pressure or a restricted state (a state in which the approach of the clamping members is restricted by the restricting members). FIG. 10 shows the dehydration apparatus 10 in a restricted state. In the pressed state, pressure is applied to the raw veneer GV such that the thickness of the raw veneer GV is compressed at a compression rate of approximately 40 to 50% (the target pressure is determined to obtain this compression rate). In addition, the control unit 2a controls the drive unit 4 to drive the fluid cylinder 131, thereby maintaining the pressed state for a predetermined time set in advance. Note that the predetermined time may be a fixed value or may be a variable value that is changed by the control unit 2a according to the detection results of various sensors. After the elapse of the predetermined time, the control unit 2a controls the drive unit 4 to drive the fluid cylinder 131, so that the pressing force applied from the fluid cylinder 131 to the second clamping member 102 gradually decreases until the held state is reached. As the pressing force applied from the fluid cylinder 131 to the second clamping member 102 gradually decreases, the pressing force applied to the raw veneer GV gradually decreases, and there is almost no pressing force applied to the raw veneer GV when the held state is reached.

In the main dehydration process, the dehydration of the raw veneer GV is realized as follows, and the following effects are achieved. That is, in the main dehydration process, the raw veneer GV is compressed at a compression rate of approximately 40 to 50% as described above. First, by compressing the raw veneer GV at such a high compression rate, moisture is sufficiently squeezed out of the raw veneer GV, and the raw veneer GV is dehydrated with a high dehydration effect. Then, the raw veneer GV is pressed while being heated by the first heating plate 101a and the second heating plate 102a. By heating the raw veneer GV in this manner, the flexibility and elasticity of the fibers of the raw veneer GV increases, and the elasticity range expands. For this reason, even when compressed at a high compression rate, breakage of the fibers is suppressed due to the improved flexibility and elasticity. This effectively prevents the strength of the veneer from decreasing compared to the conventional technique in which the veneer V is pressed and dehydrated at room temperature. In addition, even though the raw veneer GV is compressed at a high compression rate, due to the expansion of the elasticity range of the fibers, a large restoring force is obtained that allows the thickness dimension of the veneer GV to fully recover when released from the pressure applied by the first clamping member 101 and the second clamping member 102. Therefore, it is possible to prevent thickness insufficiency from occurring compared to the conventional technique in which the veneer Vis pressed and dehydrated at room temperature.

Here, the first set value TA1 set for the first target temperature is determined to reflect a viewpoint such as the viewpoint KX2: “the first target temperature is set to a temperature equal to or higher than a ‘temperature at which flexibility and elasticity necessary for the fibers of the raw veneer GV are obtained and the expansion of the necessary elasticity range is obtained due to heat generated by the first heating plate 101a’”. The “necessary flexibility and elasticity” in this viewpoint KX2 means flexibility and elasticity that can effectively prevent the strength of the veneer from decreasing. In addition, “expansion of the necessary elasticity range” means the expansion of the elasticity range that can effectively suppress the occurrence of insufficient thickness.

In addition, during the main dehydration process, the temperature of the first clamping member 101 (first heating plate 101a) is set to be lower than the temperature of the second clamping member 102 (second heating plate 102a). Then, the second clamping member 102 on the higher temperature side is not provided with a member equivalent to the interposed plate 111 with a groove formed therein, and the “front surface 102F of the second heating plate 102a”, which is a smooth surface, is in contact with the raw veneer GV. In addition, the first clamping member 101 on the lower temperature side is provided with the interposed plate 111, and the “front surface 111F of the interposed plate 111” on which the interposed plate front groove 111a is formed is in contact with the raw veneer GV. Due to the above configuration, during the main dehydration process, moisture expands on the second clamping member 102 side, which has a higher temperature, in the raw veneer GV clamped between the clamping members, and the generated steam is pushed out toward the first clamping member 101 side. Therefore, within the raw veneer GV, a consistent moisture flow from the second clamping member 102 side to the first clamping member 101 side is formed and moisture is pushed out and discharged from the surface on the first clamping member 101 side, so that the moisture in the raw veneer GV is efficiently discharged to the outside. Then, due to the efficient discharge of moisture, sufficient dehydration with little residual moisture is realized.

Here, the viewpoints KX1 and KX3 regarding the first target temperature and the viewpoints KY1 and KY2 regarding the second target temperature are viewpoints for realizing efficient discharge of moisture from the raw veneer GV.

In addition, in the main dehydration process, liquid water (hereinafter, referred to as “treated water”) dehydrated from the raw veneer GV contains tar and other impurities (hereinafter, referred to as “tar and the like”). In the main dehydration process, most of the treated water is discharged from a surface (hereinafter, referred to as a “discharge surface”) of the raw veneer GV in contact with the “interposed plate 111 of the first clamping member 101” according to the flow of water from the second clamping member 102 side to the first clamping member 101 side. Most of the treated water discharged from the discharge surface enters the interposed plate front groove 111a formed on the front surface 111F of the interposed plate 111. Then, a part of the treated water that has entered the interposed plate front groove 111a flows through the interposed plate front groove 111a due to gravity and is discharged from the end of the groove. In addition, a part of the treated water that has entered the interposed plate front groove 111a enters the interposed plate back groove 111b through the through hole apl, flows downward within the interposed plate back groove 111b due to gravity, and is discharged from the end of the groove. The treated water discharged from the discharge surface of the raw veneer GV in this manner is quickly discharged from the first clamping member 101 through the interposed plate front groove 111a and the interposed plate back groove 111b while the contact with the raw veneer GV is being suppressed. Therefore, it is possible to significantly reduce the evaporation of treated water in a state in which the first clamping member 101 is in contact with the treated water, and it is possible to significantly reduce the accumulation of tar and the like on the first clamping member 101.

Here, when the interposed plate 111 is not provided in the first clamping member 101 and the “front surface 101F of the first heating plate 101a”, which is a smooth surface, is brought into contact with the raw veneer GV during the dehydration process, the following problems may arise. That is, the treated water discharged from the discharge surface of the raw veneer GV evaporates on the front surface 101F of the first heating plate 101a, and the tar and the like contained in the treated water gradually remain, adhere, and accumulate on the front surface 101F. The tar and the like accumulated on the front surface 101F may inhibit the contact between the front surface 101F and the raw veneer GV, resulting in a decrease in heat conduction efficiency or an accompanying decrease in dehydration efficiency. In addition, there may occur a problem that dents are formed on the surface of the raw veneer GV due to deposits of tar and the like or a problem that smooth loading and unloading of the veneer V are not possible due to deposits of tar and the like at the time of loading and unloading of the veneer V. On the other hand, according to the configuration of the present embodiment, the presence of the interposed plate 111 can significantly reduce the accumulation of tar and the like on the first clamping member 101, thereby effectively solving the problems described above.

In addition, in the present embodiment, the raw veneer GV is clamped by the clamping members with its fiber direction aligned with the up-down direction. Then, a plurality of interposed plate front grooves 111a extending obliquely with respect to the up-down direction are formed on the front surface 111F of the interposed plate 111. For this reason, while the raw veneer GV is being pressed, the direction in which the interposed plate front groove 111a extends and the fiber direction of the raw veneer GV do not match each other, but cross each other at an angle of “the inclination of the direction in which the interposed plate front groove 111a extends” (approximately 45°). When the raw veneer GV is pressed while the direction in which the interposed plate front groove 111a extends matches the fiber direction, the edges of the interposed plate front groove 111a are likely to bite into the raw veneer GV. However, in the present embodiment, since the direction in which the interposed plate front groove 111a extends crosses the fiber direction, the occurrence of such “biting”can be effectively suppressed.

In addition, the interposed plate front groove 111a extends in a direction inclined with respect to the up-down direction. That is, the interposed plate front groove 111a does not extend in a direction perpendicular to the up-down direction, but extends in a direction that includes a downward (=downward in the vertical direction) component. As described above, during the main dehydration process, liquid treated water is discharged from the raw veneer GV and flows into the interposed plate front groove 111a. However, since the interposed plate front groove 111a extends in a direction that includes a downward (that is, downward in the vertical direction) component, the liquid treated water that has flowed into the interposed plate front groove 111a can be efficiently discharged. In addition, the through hole ap1 is formed at a point where the interposed plate front groove 111a and the interposed plate back groove 111b cross each other, and a part of the liquid entering the interposed plate front groove 111a enters the interposed plate back groove 111b through the through hole ap1 and is discharged to the outside through the interposed plate back groove 111b. For this reason, it is possible to suppress the overflow of treated water within the interposed plate front groove 111a. Therefore, it is possible to realize more efficient discharge of the treated water and more effective suppression of the accumulation of deposits on the first clamping member 101.

Note that, in this modification example, the “inclination of the direction in which the interposed plate front groove 111a extends with respect to the up-down direction” is set to 45°, but the inclination is not limited to 45°. That is, the interposed plate front groove 111a may include a vertically downward component and may be oriented in a direction crossing the fiber direction of the raw veneer GV being clamped.

Note that the actual temperature of the first set value TA1 set as the first target temperature is to be changed depending on the length of time the pressed state is maintained during the main dehydration process, the target pressure, the thermal conductivity of the interposed plate 111, the ambient temperature, and other factors, but is set to a temperature within the range of 60 to 150° C. as an example. In addition, the first set value TA1 may be changed for each dehydration process. In addition, the control unit 2a may be configured to dynamically change the first set value TA1 depending on the state of the raw veneer GV during the dehydration process. In this case, sensors (a temperature sensor, a camera, and the like) for detecting the state of the raw veneer GV are appropriately provided. Similarly, the actual temperature of the second set value TA2 set as the second target temperature is to be changed depending on various factors, but is set to a temperature within the range of 60 to 150° C. as an example. The value of the second set value TA2 may be changed for each dehydration process, or may be a variable value that changes during the dehydration process.

Now, referring to FIG. 19, after the end of the main dehydration process in step SA3, the dehydrated veneer DV is removed from the dehydration apparatus 10 and placed between the first drying side clamping member 151 and the second drying side clamping member 152 of the drying apparatus 15 (step SX2). At this time, the fiber direction of the dehydrated veneer DV is aligned with the up-down direction (=vertical direction). This is because, due to the relationship with the strength of the dehydrated veneer DV, the fiber direction of the dehydrated veneer DV should be aligned with the vertical direction. Note that the processing of step SX2 may be performed automatically by a belt conveyor, an industrial robot, or other equipment. In addition, this process may be performed partially or entirely by human means. The following processes in steps SA4 to SA6 are performed for the drying apparatus 15.

Then, the control unit 2a performs a drying side holding process (step SA4). More specifically, the control unit 2a controls the drying side drive unit 6 to drive the drying side fluid cylinder 181, so that the second drying side clamping member 152 is pressed leftward to hold the dehydrated veneer DV between the first drying side clamping member 151 and the second drying side clamping member 152. At this stage, a weak pressure sufficient to maintain the state of being clamped by the clamping members is applied to the dehydrated veneer DV.

Then, the control unit 2a performs a drying side heating process (step SA5). More specifically, a value to be set as a first drying side target temperature for the first drying side heating plate 151a of the first drying side clamping member 151 (hereinafter, referred to as a “first drying side set value TB1”) and a value to be set as a second drying side target temperature for the second drying side heating plate 152a of the second drying side clamping member 152 (hereinafter, referred to as a “second drying side set value TB2”) are determined in advance based on the following viewpoints.
(Viewpoint KZ1) The first drying side target temperature is set sufficiently lower than the second drying side target temperature.
(Viewpoint KZ2) The first drying side target temperature and the second drying side target temperature are set to temperatures at which the moisture remaining in the dehydrated veneer DV can be vaporized and discharged during the main drying process, and set to temperatures at which excessive drying does not occur.

In the drying side heating process of step SA5, the control unit 2a controls the drying side heating unit 5 to heat the first drying side heating plate 151a so that the temperature of the first drying side heating plate 151a becomes the first drying side set value TB1 (=the value set as the first drying side target temperature). In addition, the control unit 2a controls the drying side heating unit 5 to heat the second drying side heating plate 152a so that the temperature of the second drying side heating plate 152a becomes the second drying side set value TB2 (=the value set as the second drying side target temperature).

Note that the timing for starting the heating process is not limited to the timing exemplified in the present embodiment. As an example, the heating process may be started before the start of the drying side holding process.

Then, the control unit 2a performs a main drying process (step SA6). More specifically, the control unit 2a continues the state in which the dehydrated veneer DV is held by the clamping members for a predetermined time. While the main drying process continues, the dehydrated veneer DV is heated by the first drying side heating plate 151a, which generates heat at the first drying side set value TB1, and the second drying side heating plate 152a, which generates heat at the second drying side set value TB2, and the moisture inside is discharged as steam, thereby realizing the drying of the dehydrated veneer DV.

With the above-described structural features, the drying process is performed by the drying apparatus 15, and the following effects are achieved. That is, in the main drying process, the dehydrated veneer DV held by the clamping members is heated by the heat generated by the heating plates, and the moisture inside is discharged as steam. Then, the steam generated from the dehydrated veneer DV is quickly discharged through the drying side interposed plate front groove 161a of the drying side interposed plate 161 of the first drying side clamping member 151 and the drying side interposed plate front groove 161a of the drying side interposed plate 161 of the second drying side clamping member 152. Since this prevents the discharged steam from stagnating, it is possible to prevent tar and the like mixed in the steam from adhering to and accumulating on the first drying side clamping member 151 and the second drying side clamping member 152.

Here, during the main drying process, the steam discharged from the surface of the dehydrated veneer DV on the side of the first drying side clamping member 151 flows into the drying side interposed plate front groove 161a formed on the front surface 161F of the drying side interposed plate 161, and a part of the steam enters the drying side interposed plate back groove 161b through the through hole ap2 and is discharged through the drying side interposed plate back groove 161b. This configuration can prevent steam from overflowing within the drying side interposed plate front groove 161a. Therefore, it is possible to realize more efficient discharge of steam and more effective suppression of the accumulation of deposits on the first drying side clamping member 151. The same is true for the steam discharged from the surface of the dehydrated veneer DV on the side of the second drying side clamping member 152.

In addition, the drying side interposed plate front groove 161a of the drying side interposed plate 161 extends in a direction perpendicular to the up-down direction, in other words, in a direction perpendicular to the fiber direction of the clamped dehydrated veneer DV. Therefore, it is possible to effectively suppress the occurrence of “biting” of the edges of the interposed plate front groove 111a into the dehydrated veneer DV. However, in the main drying process, since the pressure applied to the second drying side clamping member 152 is small, the edges of the interposed plate front groove 111a are unlikely to “bite” into the dehydrated veneer DV. Note that the direction in which the drying side interposed plate front groove 161a extends is not limited to the direction “perpendicular” to the up-down direction. That is, the direction in which the drying side interposed plate front groove 161a extends may be a direction crossing the up-down direction (=the fiber direction of the clamped dehydrated veneer DV).

In addition, in the main drying process, a pair of first drying side clamping member 151 and second drying side clamping member 152 are heated to different temperatures. As a result, when the dehydrated veneer DV is held and dried in the main drying process, a difference in drying speed occurs between the surface of the dehydrated veneer DV on the side of the first drying side clamping member 151 and the surface of the dehydrated veneer DV on the side of the second drying side clamping member 152. This difference in drying speed causes a drying set effect, which can suppress deformation due to drying and moisture absorption/desorption after drying.

Note that the temperatures set as the first target temperature, the second target temperature, the first drying side target temperature, and the second drying side target temperature are not limited to specific temperatures or specific ranges. In addition, although an example of the viewpoint for setting each target temperature has been given, each target temperature may be set from a viewpoint different from the exemplified viewpoint. That is, the first target temperature and the second target temperature are required to have a relationship “first target temperature<second target temperature” and to be able to achieve the above-described effects in the dehydration process or have a tendency to achieve the effects. In addition, the first drying target temperature and the second drying target temperature are required to have a relationship “first drying target temperature<second drying target temperature” and to be able to achieve the above-described effects in the drying process or have a tendency to achieve the effects. The above also applies to other embodiments.

Note that some or all of the processes in steps SA1 to SA3 correspond to the “veneer dehydration method”. In addition, some or all of the processes in steps SA4 to SA6 correspond to the “veneer drying method”. In addition, some or all of the processes in steps SA1 to SA6 correspond to the “veneer processing method”.

As described above, in the present embodiment, the veneer V is dried in the order of dehydration process and drying process. Therefore, it is possible to stably produce the high-quality veneer V, which has the smoothness that is an advantage of heating plate drying, while maintaining its strength and having little deformation due to moisture absorption after drying.

### Embodiment 2

Next, Embodiment 2 will be described. In the following description of Embodiment 2, elements that are the same as those in Embodiment 1 or have the same functions due to the same features are denoted by the same reference numerals, and the repeated description thereof will be omitted.

FIG. 20 is a block diagram showing an example of the functional configuration of a veneer processing system 1-2 according to the present embodiment. As shown in FIG. 20, the veneer processing system 1-2 includes a dehydration apparatus 20, a drying apparatus 25, and the control apparatus 2. The dehydration apparatus 20 and the control apparatus 2 constitute a dehydration system 1a-2. The drying apparatus 25 and the control apparatus 2 constitute a drying system 1b-2.

### <Configuration of the Dehydration Apparatus 20>

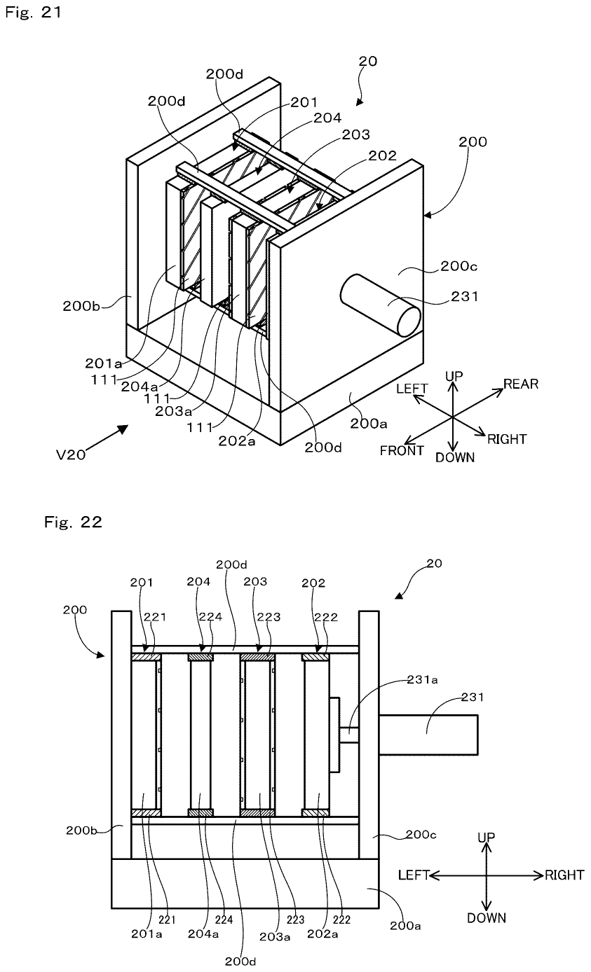

FIG. 21 is a perspective view of the dehydration apparatus 20 according to the present embodiment. FIG. 22 is a diagram of the dehydration apparatus 20 when viewed toward the arrow V20 in FIG. 21. In the following description, the front-rear direction, the front-rear direction, the up-down direction, and the left-right direction based on the dehydration apparatus 20 are defined as shown in FIGS. 21 and 22. The up-down direction matches the vertical direction when the dehydration apparatus 20 is installed in a normal operating state.

As shown in FIGS. 21 and 22, the dehydration apparatus 20 includes a frame 200. The frame 200 includes a base 200a and a plurality of support walls 200b and 200c standing on the base 200a. Between the support wall 200b and the support wall 200c, four rails 200d extending in the left-right direction are provided so as to be suspended between these members. The function of the rails 200d will be described later.

A first clamping member 201 is fixed to the support wall 200b. The first clamping member 201 includes a first heating plate 201a having a rectangular parallelepiped shape. The first heating plate 201a has a back surface that faces the support wall 200b and is fixed to the support wall 200b and a front surface on a side opposite to the back surface. The front and back surfaces of the first heating plate 201a are smooth surfaces. The first heating plate 201a is a member capable of generating heat. As shown in FIG. 20, the heating unit 3 can heat the first heating plate 201a to the set target temperature under the control of the control unit 2a. Hereinafter, the target temperature set for the first heating plate 201a will be referred to as a “first target temperature” as in Embodiment 1. A restricting member 221 for restricting the first clamping member 201 and a high-temperature clamping member 204 from coming close to each other is provided on the top and bottom surfaces of the first heating plate 201a. In the first clamping member 201, the interposed plate 111 is attached to the front surface of the first heating plate 201a. The configuration of the interposed plate 111 is the same as that described in Embodiment 1. In addition, the structural relationship between the first heating plate 201a and the interposed plate 111 is the same as the structural relationship between the first heating plate 101a and the interposed plate 111 in Embodiment 1. The same is true for other cases where the interposed plate is attached to the heating plate.

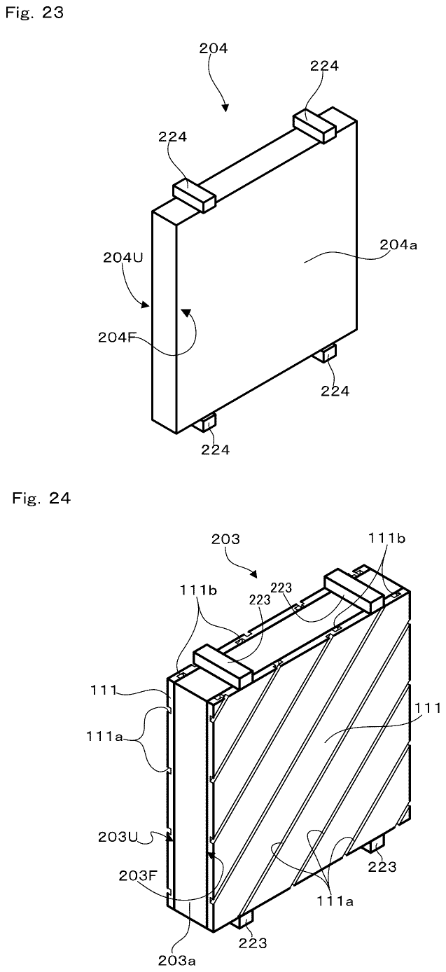

The high-temperature clamping member 204 is provided at a position facing the first clamping member 201 on the right side of the first clamping member 201. The high-temperature clamping member 204 is located between the first clamping member 201 and a low-temperature clamping member 203, which will be described later. FIG. 23 is a perspective view of the high-temperature clamping member 204. As shown in FIG. 23, the high-temperature clamping member 204 includes a high-temperature heating plate 204a having a rectangular parallelepiped shape. The high-temperature heating plate 204a has one surface 204U facing the first clamping member 201 and the other surface 204F on a side opposite to the one surface 204U. The other surface 204F faces the low-temperature clamping member 203. The high-temperature heating plate 204a is a member capable of generating heat. As shown in FIG. 20, the heating unit 3 can heat the high-temperature heating plate 204a to the set target temperature under the control of the control unit 2a. Hereinafter, the target temperature set for the high-temperature heating plate 204a will be referred to as a “high-temperature target temperature”. The high-temperature clamping member 204 does not include a member equivalent to the interposed plate 111.

On the top and bottom surfaces of the high-temperature heating plate 204a, a restricting member 224 for restricting the high-temperature clamping member 204 and the first clamping member 201 from coming close to each other and restricting the high-temperature clamping member 204 and the low-temperature clamping member 203 from coming close to each other is provided. As shown in FIGS. 21 and 22, four rails 200d support the high-temperature clamping member 204. In addition, the four rails 200d restrict the movement of the high-temperature clamping member 204 so that the high-temperature clamping member 204 moves only in the left-right direction. More specifically, each of the four rails 200d has a guide groove formed at an appropriate position. Each of the restricting members 224 of the high-temperature clamping member 204 is provided at a position corresponding to the rail 200d, and is fitted into each of the guide grooves of the corresponding rail 200d. Then, the restricting member 224 is fitted into each guide groove of the corresponding rail 200d, thereby restricting the movement of the high-temperature clamping member 204 so that the movement direction of the high-temperature clamping member 204 is limited only to the left-right direction.

The low-temperature clamping member 203 is provided at a position facing the high-temperature clamping member 204 on the right side of the high-temperature clamping member 204. The low-temperature clamping member 203 is located between the high-temperature clamping member 204 and a second clamping member 202. FIG. 24 is a perspective view of the low-temperature clamping member 203. As shown in FIG. 24, the low-temperature clamping member 203 includes a low-temperature heating plate 203a having a rectangular parallelepiped shape. The low-temperature heating plate 203a has one surface 203U facing the high-temperature clamping member 204 and the other surface 203F on a side opposite to the one surface 203U. The other surface 203F faces the second clamping member 202.

The low-temperature heating plate 203a is a member capable of generating heat. As shown in FIG. 20, the heating unit 3 can heat the low-temperature heating plate 203a to the set target temperature under the control of the control unit 2a. Hereinafter, the target temperature set for the low-temperature heating plate 203a will be referred to as a “low-temperature target temperature”.

As shown in FIG. 24, the interposed plate 111 is attached to the one surface 203U of the low-temperature clamping member 203. In addition, the interposed plate 111 is attached to the other surface 203F of the low-temperature clamping member 203. The configuration of the interposed plate 111 is the same as that described in Embodiment 1.

A restricting member 223 for restricting the low-temperature clamping member 203 and the high-temperature clamping member 204 from coming close to each other and restricting the low-temperature clamping member 203 and the second clamping member 202 from coming close to each other is provided on the top and bottom surfaces of the low-temperature heating plate 203a. The four rails 200d support the low-temperature clamping member 203. In addition, the four rails 200d restricts the movement of the low-temperature clamping member 203 so that the low-temperature clamping member 203 moves only in the left-right direction. The structural relationship between the rail 200d and the low-temperature clamping member 203 is similar to the structural relationship between the rail 200d and the high-temperature clamping member 204.

As shown in FIGS. 21 and 22, the second clamping member 202 is provided at a position facing the low-temperature clamping member 203 on the right side of the low-temperature clamping member 203. The second clamping member 202 includes a second heating plate 202a having a rectangular parallelepiped shape. The second heating plate 202a has a front surface facing the low-temperature clamping member 203 and a back surface on a side opposite to the front surface. The second heating plate 202a is a member capable of generating heat. As shown in FIG. 20, the heating unit 3 can heat the second heating plate 202a to the set target temperature under the control of the control unit 2a. Hereinafter, the target temperature set for the second heating plate 202a will be referred to as a “second target temperature” as in Embodiment 1.

On the top and bottom surfaces of the second heating plate 202a, a restricting member 222 for restricting the second clamping member 202 and the low-temperature clamping member 203 from coming close to each other is provided. The four rails 200d support the second clamping member 202. In addition, the four rails 200d restrict the movement of the second clamping member 202 so that the second clamping member 202 moves only in the left-right direction. The structural relationship between the rail 200d and the second clamping member 202 is similar to the structural relationship between the rail 200d and the high-temperature clamping member 204.

A fluid cylinder 231 that can press the second clamping member 202 is provided on the support wall 200c. The fluid cylinder 231 includes a piston rod 231a, which is an operating shaft. The tip of the piston rod 231a is connected to the second clamping member 202. As shown in FIG. 20, the drive unit 4 drives the fluid cylinder 231 under the control of the control unit 2a, so that the second clamping member 202 can be pressed by the fluid cylinder 231.

The dehydration apparatus 20 according to the present embodiment can simultaneously press three raw veneers GV. More specifically, the dehydration apparatus 20 can press the raw veneer GV between the first clamping member 201 and the high-temperature clamping member 204, press the raw veneer GV between the high-temperature clamping member 204 and the low-temperature clamping member 203, and press the raw veneer GV between the low-temperature clamping member 203 and the second clamping member 202. Hereinafter, the raw veneer GV clamped between the first clamping member 201 and the high-temperature clamping member 204 will be referred to as a “first raw veneer GV1”, the raw veneer GV clamped between the high-temperature clamping member 204 and the low-temperature clamping member 203 will be referred to as a “second raw veneer GV2”, and the raw veneer GV clamped between the low-temperature clamping member 203 and the second clamping member 202 will be referred to as a “third raw veneer GV3”.

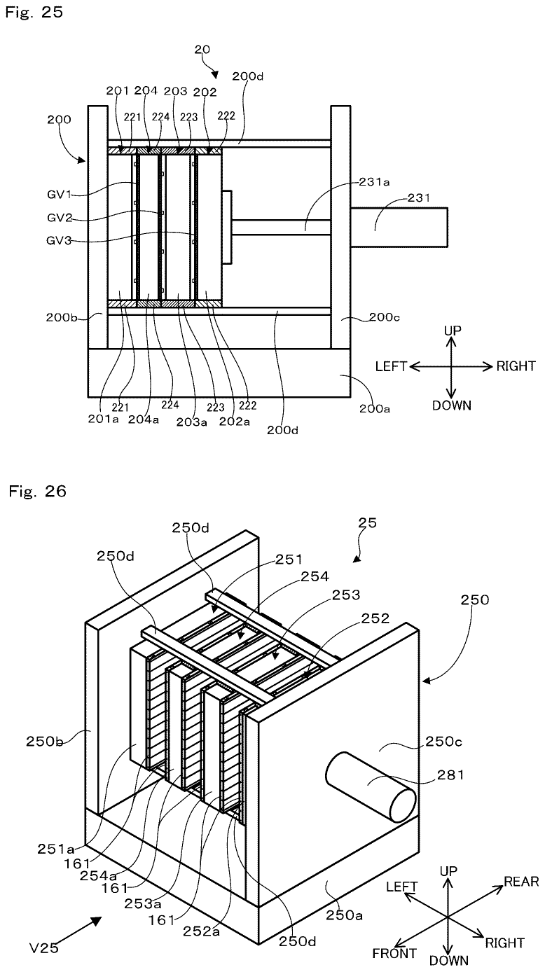

More specifically, when the second clamping member 202 is pressed leftward by the fluid cylinder 131 in a state in which the first raw veneer GV1 is located between the first clamping member 201 and the high-temperature clamping member 204, the second raw veneer GV2 is located between the high-temperature clamping member 204 and the low-temperature clamping member 203, and the third raw veneer GV3 is located between the low-temperature clamping member 203 and the second clamping member 202, the low-temperature clamping member 203 and the high-temperature clamping member 204 are also pressed leftward in conjunction with this. As the pressing of the second clamping member 202 progresses, the first to third raw veneers GV1 to GV3 reach a state in which these are held by the clamping members. When the pressing of the second clamping member 202 progresses further from the held state, each of the first to third raw veneers GV1 to GV3 is pressed by the clamping members located on both sides. In response to the pressing of the second clamping member 202, each of the second clamping member 202, the low-temperature clamping member 203, and the high-temperature clamping member 204 moves leftward, but the further leftward movement is restricted when the restricted state is reached. FIG. 25 shows the dehydration apparatus 20 in a restricted state.

### <Configuration of the Drying Apparatus 25>

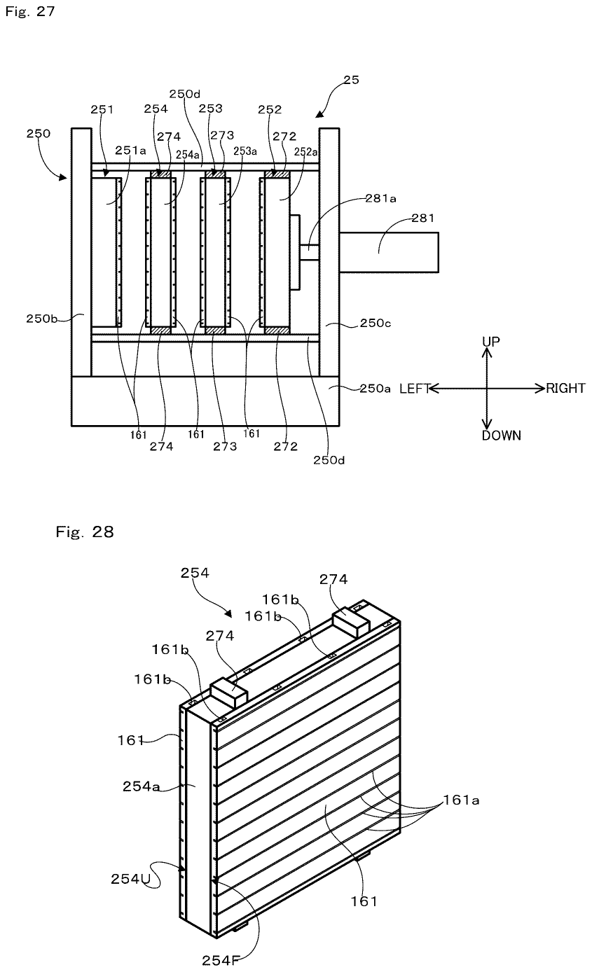

FIG. 26 is a perspective view of the drying apparatus 25 according to the present embodiment. FIG. 27 is a diagram of the drying apparatus 25 when viewed toward the arrow V25 in FIG. 26. In the following description, the front-rear direction, the up-down direction, and the left-right direction based on the drying apparatus 25 are defined as shown in FIGS. 26 and 27. The up-down direction matches the vertical direction when the drying apparatus 25 is installed in a normal operating state.

As shown in FIGS. 26 and 27, the drying apparatus 25 includes a frame 250. The frame 250 includes a base 250a and a pair of support walls 250b and 250c standing on the base 250a. Four rails 250d extending in the left-right direction are suspended between the support wall 250b and the support wall 250c.

A first drying side clamping member 251 is fixed to the support wall 250b. The first drying side clamping member 251 includes a first drying side heating plate 251a having a rectangular parallelepiped shape. The first drying side heating plate 251a has a back surface that faces the support wall 250b and is fixed to the support wall 250b and a front surface on a side opposite to the back surface. The first drying side heating plate 251a is a member capable of generating heat. As shown in FIG. 20, the drying side heating unit 5 can heat the first drying side heating plate 251a to the set target temperature under the control of the control unit 2a. Hereinafter, the target temperature set for the first drying side heating plate 251a will be referred to as a “first drying side target temperature” as in Embodiment 1. The drying side interposed plate 161 is provided on the front surface of the first drying side heating plate 251a. The configuration of the drying side interposed plate 161 is the same as that described in Embodiment 1.

A drying side high-temperature clamping member 254 is provided at a position facing the first drying side clamping member 251 on the right side of the first drying side clamping member 251. The drying side high-temperature clamping member 254 is located between the first drying side clamping member 251 and a drying side low-temperature clamping member 253, which will be described later. FIG. 28 is a perspective view of the drying side high-temperature clamping member 254. As shown in FIG. 28, the drying side high-temperature clamping member 254 includes a drying side high-temperature heating plate 254a having a rectangular parallelepiped shape. The drying side high-temperature heating plate 254a has one surface 254U facing the first drying side clamping member 251 and the other surface 254F on a side opposite to the one surface 254U. The drying side high-temperature heating plate 254a is a member capable of generating heat. As shown in FIG. 20, the drying side heating unit 5 can heat the drying side high-temperature heating plate 254a to the set target temperature under the control of the control unit 2a. Hereinafter, the target temperature set for the drying side high-temperature heating plate 254a will be referred to as a “drying side high-temperature target temperature”.

As shown in FIG. 28, the drying side interposed plate 161 is provided on the one surface 254U of the drying side high-temperature heating plate 254a. In addition, the drying side interposed plate 161 is provided on the other surface 254F. The configuration of the drying side interposed plate 161 is the same as that described in Embodiment 1.

On the top and bottom surfaces of the drying side high-temperature heating plate 254a, a moving member 274 for restricting the movement direction of the drying side high-temperature clamping member 254 is provided. Each moving member 274 fits into a guide groove of the corresponding rail 250d.

The drying side low-temperature clamping member 253 is provided at a position facing the drying side high-temperature clamping member 254 on the right side of the drying side high-temperature clamping member 254. The drying side low-temperature clamping member 253 is located between the drying side high-temperature clamping member 254 and a second drying side clamping member 252. As shown in FIGS. 26 and 27, the drying side low-temperature clamping member 253 includes a drying side low-temperature heating plate 253a having a rectangular parallelepiped shape. The drying side low-temperature heating plate 253a is a member capable of generating heat. As shown in FIG. 20, the drying side heating unit 5 can heat the drying side low-temperature heating plate 253a to the set target temperature under the control of the control unit 2a. Hereinafter, the target temperature set for the drying side low-temperature heating plate 253a will be referred to as a “drying side low-temperature target temperature”. The drying side interposed plate 161 is provided on one and the other surfaces of the drying side low-temperature heating plate 253a.

On the top and bottom surfaces of the drying side low-temperature heating plate 253a, a moving member 273 for restricting the movement direction of the drying side low-temperature clamping member 253 is provided. Each moving member 273 fits into a guide groove of the corresponding rail 250d.

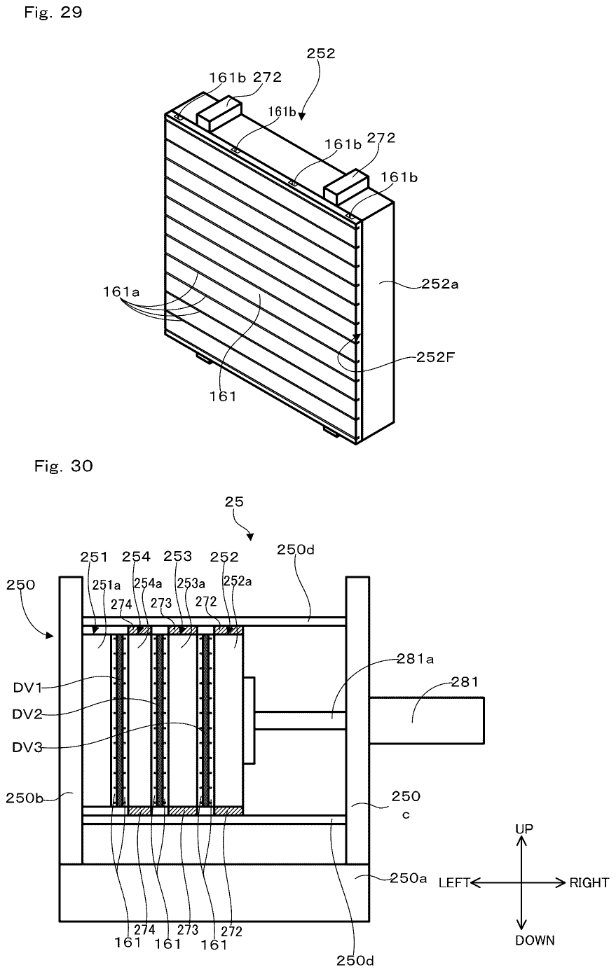

The second drying side clamping member 252 is provided at a position facing the drying side low-temperature clamping member 253 on the right side of the drying side low-temperature clamping member 253. FIG. 29 is a perspective view of the second drying side clamping member 252. As shown in FIG. 29, the second drying side clamping member 252 includes a second drying side heating plate 252a having a rectangular parallelepiped shape. The second drying side heating plate 252a is a member capable of generating heat. As shown in FIG. 20, the drying side heating unit 5 can heat the second drying side heating plate 252a to the set target temperature under the control of the control unit 2a. Hereinafter, the target temperature set for the second drying side heating plate 252a will be referred to as a “second drying side target temperature” as in Embodiment 1. The drying side interposed plate 161 is provided on the front surface 252F of the second drying side heating plate 252a.

On the top and bottom surfaces of the second drying side heating plate 252a, a moving member 272 for restricting the movement direction of the second drying side clamping member 252 is provided. Each moving member 272 fits into a guide groove of the corresponding rail 250d.

A drying side fluid cylinder 281 that can press the second drying side clamping member 252 is provided on the support wall 250c. The drying side fluid cylinder 281 includes a piston rod 281a, which is an operating shaft. As shown in FIG. 20, the drive unit 4 drives the drying side fluid cylinder 281 under the control of the control unit 2a, so that the second drying side clamping member 252 can be pressed by the drying side fluid cylinder 281.

The drying apparatus 25 can hold three dehydrated veneers DV simultaneously. More specifically, the drying apparatus 25 can hold the dehydrated veneer DV between the first drying side clamping member 251 and the drying side high-temperature clamping member 254, hold the dehydrated veneer DV between the drying side high-temperature clamping member 254 and the drying side low-temperature clamping member 253, and hold the dehydrated veneer DV between the drying side low-temperature clamping member 253 and the second drying side clamping member 252. FIG. 30 shows the drying apparatus 25 in a held state. Hereinafter, the dehydrated veneer DV clamped between the first drying side clamping member 251 and the drying side high-temperature clamping member 254 will be referred to as a “first dehydrated veneer DV1”, the dehydrated veneer DV clamped between the drying side high-temperature clamping member 254 and the drying side low-temperature clamping member 253 will be referred to as a “second dehydrated veneer DV2”, and the dehydrated veneer DV clamped between the drying side low-temperature clamping member 253 and the second drying side clamping member 252 will be referred to as a “third dehydrated veneer DV3”.

### <Operation of the Veneer Processing System 1-2>

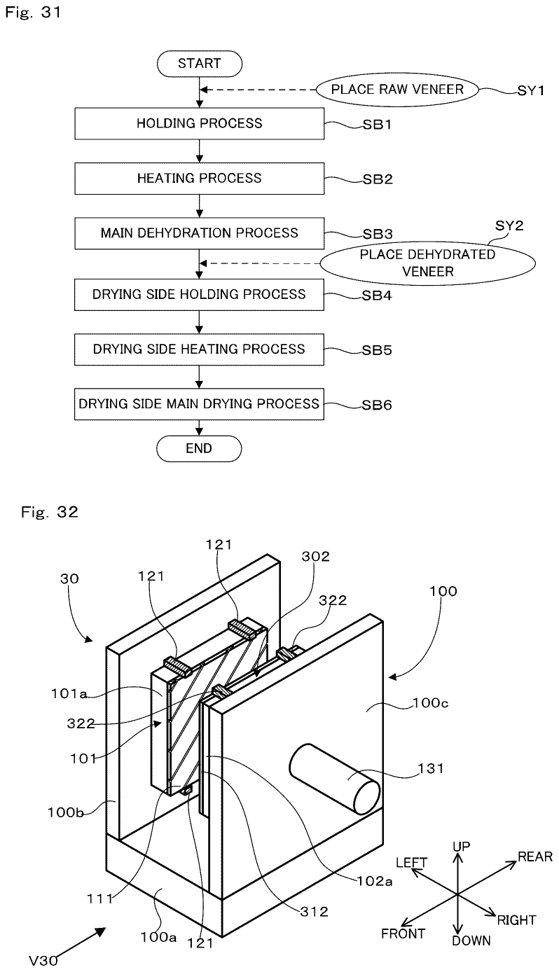

Next, the operation of the veneer processing system 1-2 when a dehydration process by the dehydration apparatus 20 and a drying process by the drying apparatus 25 are performed will be described with reference to the flowchart of FIG. 31.

As shown in FIG. 31, the first raw veneer GV1 is placed between the first clamping member 201 and the high-temperature clamping member 204 of the dehydration apparatus 20, the second raw veneer GV2 is placed between the high-temperature clamping member 204 and the low-temperature clamping member 203, and the third raw veneer GV3 is placed between the low-temperature clamping member 203 and the second clamping member 202 (step SY1). At this time, for each of the first to third raw veneers GV1 to GV3, the fiber direction of the dehydrated veneer DV and the up-down direction (=vertical direction) are aligned. The following processes in steps SB1 to SB3 are performed for the dehydration apparatus 20.

Then, the control unit 2a performs a holding process (step SB1). More specifically, the control unit 2a controls the drive unit 4 to drive the fluid cylinder 131, so that the second clamping member 102 is pressed leftward to hold the first raw veneer GV1 between the first clamping member 201 and the high-temperature clamping member 204, hold the second raw veneer GV2 between the high-temperature clamping member 204 and the low-temperature clamping member 203, and hold the third raw veneer GV3 between the low-temperature clamping member 203 and the second clamping member 202.

Then, the control unit 2a performs a heating process (step SB2). More specifically, the control unit 2a sets a first target temperature for the first heating plate 201a of the first clamping member 201 to the first set value TA1 described in Embodiment 1. In addition, the control unit 2a sets a high-temperature target temperature for the high-temperature heating plate 204a of the high-temperature clamping member 204 to the second set value TA2 (>first set value TA1) shown in Embodiment 1. In addition, the control unit 2a sets a low-temperature target temperature for the low-temperature heating plate 203a of the low-temperature clamping member 203 to the first set value TA1 shown in Embodiment 1. In addition, the control unit 2a sets a second target temperature for the second heating plate 202a of the second clamping member 202 to the second set value TA2 (>first set value TA1) shown in Embodiment 1. The above is summarized as follows.
First target temperature=low-temperature target temperature=first set value TA1 (<second set value TA2)
High-temperature target temperature=second target temperature=second set value TA2 (>first set value TA1)

In the heating process of step SB2, the control unit 2a controls the heating unit 3 to heat each heating plate, that is, each of the first heating plate 201a, the high-temperature heating plate 204a, the low-temperature heating plate 203a, and the second heating plate 202a to the corresponding target temperature.

Then, the control unit 2a performs a main dehydration process (step SB3). More specifically, the control unit 2a controls the drive unit 4 to drive the fluid cylinder 231, so that the second clamping member 202 is pressed to cause a pressed state. The pressed state is either a state in which the pressure applied to the first to third raw veneers GV1 to GV3 reaches a target pressure or a restricted state. FIG. 30 shows the dehydration apparatus 20 in a restricted state. Note that, in the pressed state, pressure is applied to each of the first to third raw veneers GV1 to GV3 such that the thickness of each of the first to third raw veneers GV1 to GV3 is compressed at a compression rate of approximately 40 to 50%. The value of the target pressure is determined in advance based on this viewpoint. In addition, the control unit 2a controls the drive unit 4 to drive the fluid cylinder 231, thereby maintaining the pressed state for a predetermined time set in advance. After the elapse of the predetermined time, the control unit 2a controls the drive unit 4 to drive the fluid cylinder 231, so that the pressing force applied from the fluid cylinder 231 to the second clamping member 202 gradually decreases until the held state is reached. As the pressing force applied from the fluid cylinder 231 to the second clamping member 202 gradually decreases, the pressing force applied to the first to third raw veneers GV1 to GV3 gradually decreases, and there is almost no pressing force applied to the first to third raw veneers GV1 to GV3 when the held state is reached.

In the main dehydration process, each of the first to third raw veneers GV1 to GV3 is dehydrated in the same state as the raw veneer GV in Embodiment 1. That is, focusing on the first raw veneer GV1, the first raw veneer GV1 is subjected to the main dehydration process while being pressed by the first clamping member 201 and the high-temperature clamping member 204. At this time, for the first raw veneer GV1, the first clamping member 201 plays the same role as the first clamping member 101 according to Embodiment 1, and the high-temperature clamping member 204 plays the same role as the second clamping member 102 according to Embodiment 1. Therefore, it is possible to dehydrate the first raw veneer GV1 while achieving the same effects as in Embodiment 1.

In addition, focusing on the second raw veneer GV2, the second raw veneer GV2 is subjected to the main dehydration process while being pressed by the high-temperature clamping member 204 and the low-temperature clamping member 203. At this time, for the second raw veneer GV2, the low-temperature clamping member 203 plays the same role as the first clamping member 101 according to Embodiment 1, and the high-temperature clamping member 204 plays the same role as the second clamping member 102 according to Embodiment 1. Therefore, it is possible to dehydrate the second raw veneer GV2 while achieving the same effects as in Embodiment 1. In addition, focusing on the third raw veneer GV3, the third raw veneer GV3 is subjected to the main dehydration process while being pressed by the low-temperature clamping member 203 and the second clamping member 202. At this time, for the third raw veneer GV3, the low-temperature clamping member 203 plays the same role as the first clamping member 101 according to Embodiment 1, and the second clamping member 202 plays the same role as the second clamping member 102 according to Embodiment 1. Therefore, it is possible to dehydrate the third raw veneer GV3 while achieving the same effects as in Embodiment 1.

According to the dehydration apparatus 20 according to the present embodiment, a plurality of raw veneers GV can be simultaneously processed in one operation. In addition, when heating both surfaces of each raw veneer V to different temperatures, there is no need to create a high-temperature portion and a low-temperature portion within the same heating plate. Therefore, it is possible to heat the heating plate without lowering energy efficiency.

Now, referring to FIG. 31, after the end of the main dehydration process in step SB3, the first to third dehydrated veneers DV1 to DV3 are removed from the dehydration apparatus 20. Then, the first dehydrated veneer DV1 is placed between the first drying side clamping member 251 and the drying side high-temperature clamping member 254 of the drying apparatus 25, the second dehydrated veneer DV2 is placed between the drying side high-temperature clamping member 254 and the drying side low-temperature clamping member 253, and the third dehydrated veneer DV3 is placed between the drying side low-temperature clamping member 253 and the second drying side clamping member 252 (step SY2). At this time, for each of the first to third dehydrated veneers DV1 to DV3, the fiber direction of the dehydrated veneer DV is aligned with the up-down direction (=vertical direction). The following processes in steps SB4 to SB6 are performed for the drying apparatus 25.

Then, the control unit 2a performs a drying side holding process (step SB4). More specifically, the control unit 2a controls the drying side drive unit 6 to drive the drying side fluid cylinder 281, so that the second drying side clamping member 252 is pressed leftward to hold the first dehydrated veneer DV1 between the first drying side clamping member 251 and the drying side high-temperature clamping member 254, hold the second dehydrated veneer DV2 between the drying side high-temperature clamping member 254 and the drying side low-temperature clamping member 253, and hold the third dehydrated veneer DV3 between the drying side low-temperature clamping member 253 and the second drying side clamping member 252.

Then, the control unit 2a performs a drying side heating process (step SB5). More specifically, the control unit 2a sets the first drying side target temperature for the first drying side heating plate 251a of the first drying side clamping member 251 to the first drying side set value TB1 shown in Embodiment 1. In addition, the control unit 2a sets the drying side high-temperature target temperature for the drying side high-temperature heating plate 254a of the drying side high-temperature clamping member 254 to the second drying side set value TB2 (>first drying side set value TB1) shown in Embodiment 1. In addition, the control unit 2a sets the drying side low-temperature target temperature for the drying side low-temperature heating plate 253a of the drying side low-temperature clamping member 253 to the first drying side set value TB1 shown in Embodiment 1. In addition, the control unit 2a sets the second drying side target temperature for the second drying side heating plate 252a of the second drying side clamping member 252 to the second drying side set value TB2 (>first drying side set value TB1) shown in Embodiment 1. The above is summarized as follows.
First drying side target temperature=drying side low-temperature target temperature=first drying side set value TB1 (<second drying side set value TB2)
Drying side high-temperature target temperature=second drying side target temperature=second drying side set value TB2 (>first drying side set value TB1)

The control unit 2a controls the heating unit 3 to heat each heating plate, that is, each of the first drying side heating plate 251a, the drying side high-temperature heating plate 254a, the drying side low-temperature heating plate 253a, and the second drying side heating plate 252a to the corresponding target temperature.

Then, the control unit 2a performs a main dehydration process (step SB6). More specifically, the control unit 2a continues the state in which the first to third dehydrated veneers DV1 to DV3 are held by the clamping members for a predetermined time. While the main drying process continues, the first to third dehydrated veneers DV1 to DV3 are heated by the first drying side heating plate 251a, the drying side low-temperature heating plate 253a, the drying side high-temperature heating plate 254a, and the second drying side heating plate 252a, and the moisture inside is discharged as steam, thereby realizing the drying of the first to third dehydrated veneers DV1 to DV3.

In the main drying process, each of the first to third dehydrated veneers DV1 to DV3 is dried under the same conditions as the dehydrated veneer DV in Embodiment 1. That is, focusing on the first dehydrated veneer DV1, the first dehydrated veneer DV1 is subjected to the main drying process while being clamped between the first drying side clamping member 251 and the drying side high-temperature clamping member 254. At this time, for the first dehydrated veneer DV1, the first drying side clamping member 251 plays the same role as the first drying side clamping member 151 according to Embodiment 1, and the drying side high-temperature clamping member 254 plays the same role as the second drying side clamping member 152 according to Embodiment 1. Therefore, it is possible to dry the first dehydrated veneer DV1 while achieving the same effects as in Embodiment 1.

In addition, focusing on the second dehydrated veneer DV2, the second dehydrated veneer DV2 is subjected to the main drying process while being clamped between the drying side high-temperature clamping member 254 and the drying side low-temperature clamping member 253. At this time, for the second dehydrated veneer DV2, the drying side low-temperature clamping member 253 plays the same role as the first drying side clamping member 151 according to Embodiment 1, and the drying side high-temperature clamping member 254 plays the same role as the second drying side clamping member 152 according to Embodiment 1. Therefore, it is possible to dehydrate the second dehydrated veneer DV2 while achieving the same effects as in Embodiment 1. In addition, focusing on the third dehydrated veneer DV3, the third dehydrated veneer DV3 is subjected to the main drying process while being clamped between the drying side low-temperature clamping member 253 and the second drying side clamping member 252. At this time, for the third dehydrated veneer DV3, the drying side low-temperature clamping member 253 plays the same role as the first drying side clamping member 151 according to Embodiment 1, and the second drying side clamping member 252 plays the same role as the second drying side clamping member 152 according to Embodiment 1. Therefore, it is possible to dehydrate the third dehydrated veneer DV3 while achieving the same effects as in Embodiment 1.

According to the dehydration apparatus 20 according to the present embodiment, a plurality of dehydrated veneers DV can be simultaneously processed in one operation. In addition, when heating both surfaces of each raw veneer V to different temperatures, there is no need to create a high-temperature portion and a low-temperature portion within the same heating plate. Therefore, it is possible to heat the heating plate without lowering energy efficiency. However, when energy efficiency is not taken into consideration, the following configuration may be used, for example. That is, a heating plate (hereinafter, referred to as a “special heating plate”) is provided between the first clamping member 201 and the second clamping member 202. Then, the special heating plate is configured so that the temperature of one surface facing the first clamping member 201 can be made different from the temperature of the other surface facing the second clamping member 202. Then, during the dehydration process, the raw veneer GV is pressed by the special heating plate and the first clamping member 201, and the target temperature of one surface (a surface facing the first clamping member 201) is set to the first set value TA1. At the same time, the raw veneer GV is pressed by the special heating plate and the second clamping member 202, and the target temperature of the other surface (a surface facing the second clamping member 202) is set to the second set value TA2. The above configuration can be adopted. In this case, a plurality of special heating plates can be placed between the first clamping member 201 and the second clamping member 202.

Note that, in the dehydration apparatus 20 of FIG. 21, one high-temperature clamping member 204 and one low-temperature clamping member 203 are provided between the first clamping member 201 and the second clamping member 202. However, the configuration of the dehydration apparatus 10 is not limited to this. Additional high-temperature clamping members 204 and low-temperature clamping members 203 may be provided, and the size of the frame 200, the length of the fluid cylinder 231 in the operating direction, and the operating amount of the fluid cylinder 231 may be extended according to the increase. In this case, the number of sheets that can be processed in one operation can be further increased. In the case of the present embodiment, the first clamping member 201, the high-temperature clamping member 204, the low-temperature clamping member 203, the high-temperature clamping member 204, the low-temperature clamping member 203,. the second clamping member 202 are arranged. Note that, similarly in the drying apparatus 25, a plurality of drying side high-temperature clamping members 254 and drying side low-temperature clamping members 253 may be provided, and the size of the frame 250 and the operating amount of the drying side fluid cylinder 281 may be adjusted according to the increase.

In addition, the second drying side clamping member 252 of the drying apparatus 25 may be supported by the drying side fluid cylinder 281, so that the moving member 272 is not provided on the second drying side clamping member 252.

Note that, in Embodiment 2, when the dehydration process is performed by the dehydration apparatus 20, it does not necessarily mean that the drying process should be performed by the drying apparatus 25. As an example, three veneers V dehydrated by the dehydration apparatus 20 may be dried one by one by the drying apparatus 15 according to Embodiment 1. Similarly, when the drying process is performed by the drying apparatus 25, it does not necessarily mean that the dehydration process should be performed by the dehydration apparatus 20 in advance.

### Embodiment 3

Next, Embodiment 3 will be described. In the following description of Embodiment 3, elements that are the same as those in Embodiment 1 or have the same functions due to the same features are denoted by the same reference numerals, and the repeated description thereof will be omitted.

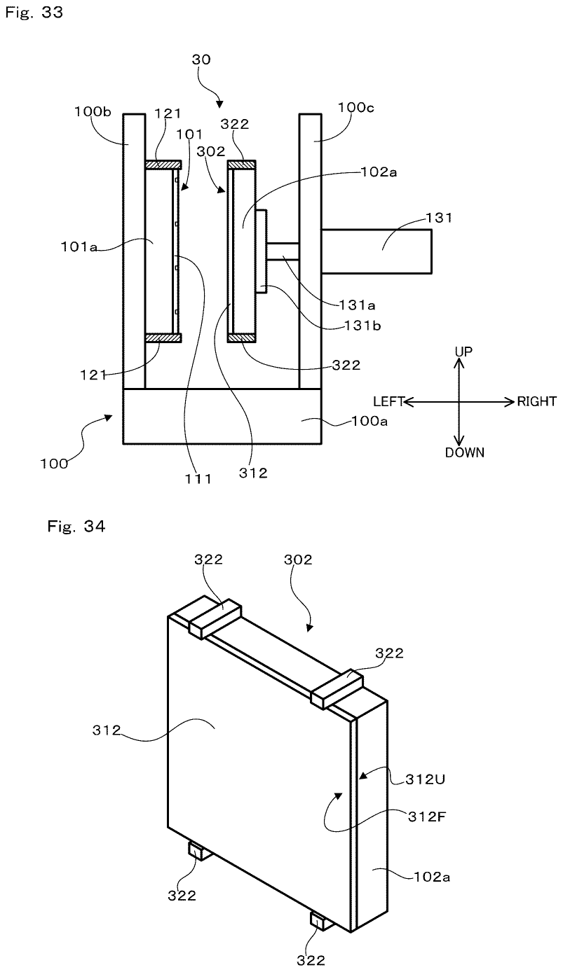

Embodiment 3 is a modification example of the dehydration apparatus 10 according to Embodiment 1. FIG. 32 is a perspective view of a dehydration apparatus 30 according to the present embodiment. FIG. 33 is a diagram of the dehydration apparatus 30 when viewed from the arrow V30 in FIG. 32. As is clear from a comparison between FIG. 3 and FIG. 32 and a comparison between FIG. 4 and FIG. 33, the dehydration apparatus 30 is different from the dehydration apparatus 10 according to Embodiment 1 in that the dehydration apparatus 30 includes a second clamping member 302 instead of the second clamping member 102 according to Embodiment 1.

FIG. 34 is a perspective view of the second clamping member 302. As shown in FIG. 34, the second clamping member 302 includes the second heating plate 102a and a flat clamping plate 312. The flat clamping plate 312 has a back surface 312U and a front surface 312F on a side opposite to the back surface 312U. The back surface 312U is in contact with the front surface of the second heating plate 102a. The front surface 312F is in contact with the surface of the raw veneer GV during the dehydration process. The flat clamping plate 312 is detachably attached to the second heating plate 102a. In addition, the second clamping member 302 includes a restricting member 322 that corresponds to the restricting member 122 and is extended to match the thickness of the flat clamping plate 312.

According to the present embodiment, the following effects are achieved. That is, the second heating plate 102a has a higher temperature than the first heating plate 101a during the main dehydration process (step SA3 in FIG. 19). Here, in the main dehydration process, the flow of water from the second heating plate 102a side to the first heating plate 101a side is formed in the raw veneer GV. For this reason, in Embodiment 1, the accumulation of tar and the like on the front surface 102F (=a surface in contact with the raw veneer GV) of the second heating plate 102a of the second clamping member 102 is suppressed. However, the accumulation of tar and the like on the front surface 102F of the second heating plate 102a is not completely eliminated. Taking this into consideration, according to the present embodiment, the detachable flat clamping plate 312 is provided on the second heating plate 102a of the second clamping member 302, so that the second heating plate 102a and the raw veneer GV are not in direct contact with each other. Therefore, the adhesion of tar and the like to the second heating plate 102a can be prevented. In addition, any tar and the like adhering to the flat clamping plate 312 can be cleaned by removing the flat clamping plate 312 as needed. Therefore, the maintenance process for the second clamping member 302 can be further reduced.

Note that the interposed plate may also be detachable in the same manner as the flat clamping plate 312, and such a configuration makes it easier to perform maintenance such as cleaning of the heating plate to which the interposed plate is attached. This is true for all the embodiments.

### Embodiment 4

Next, Embodiment 4 will be described. In the following description of Embodiment 4, elements that are the same as those in Embodiment 2 or have the same functions due to the same features are denoted by the same reference numerals, and the repeated description thereof will be omitted.

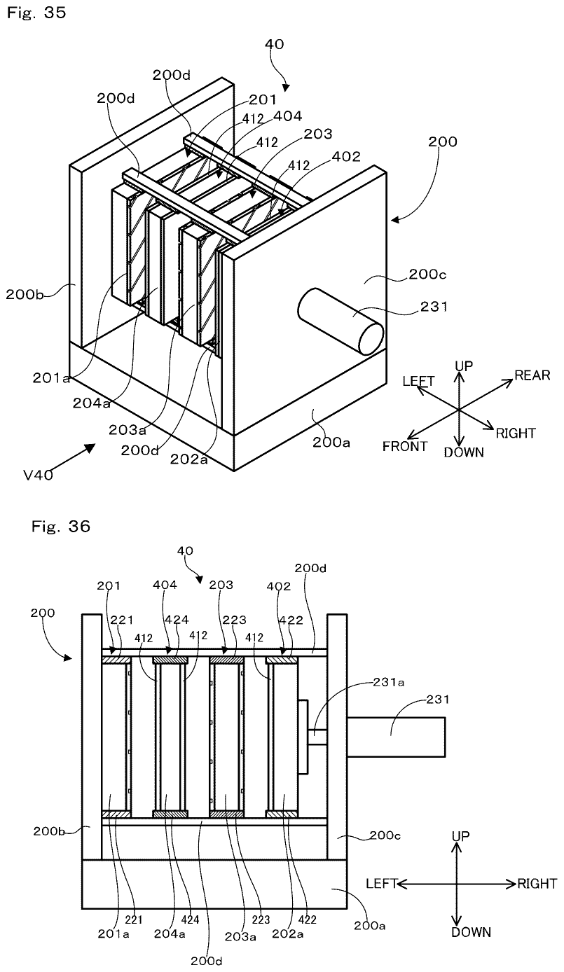

Embodiment 4 is a modification example of the dehydration apparatus 40 according to Embodiment 2. FIG. 35 is a perspective view of a dehydration apparatus 40 according to the present embodiment. FIG. 36 is a diagram of the dehydration apparatus 40 when viewed from the arrow V40 in FIG. 35. As is clear from a comparison between FIG. 21 and FIG. 35 and a comparison between FIG. 22 and FIG. 36, the dehydration apparatus 40 includes a high-temperature clamping member 404 instead of the high-temperature clamping member 204 according to Embodiment 2. In addition, the dehydration apparatus 40 includes a second clamping member 402 instead of the second clamping member 202 according to Embodiment 2. In the above points, the dehydration apparatus 40 is different from the dehydration apparatus 20 according to Embodiment 2.

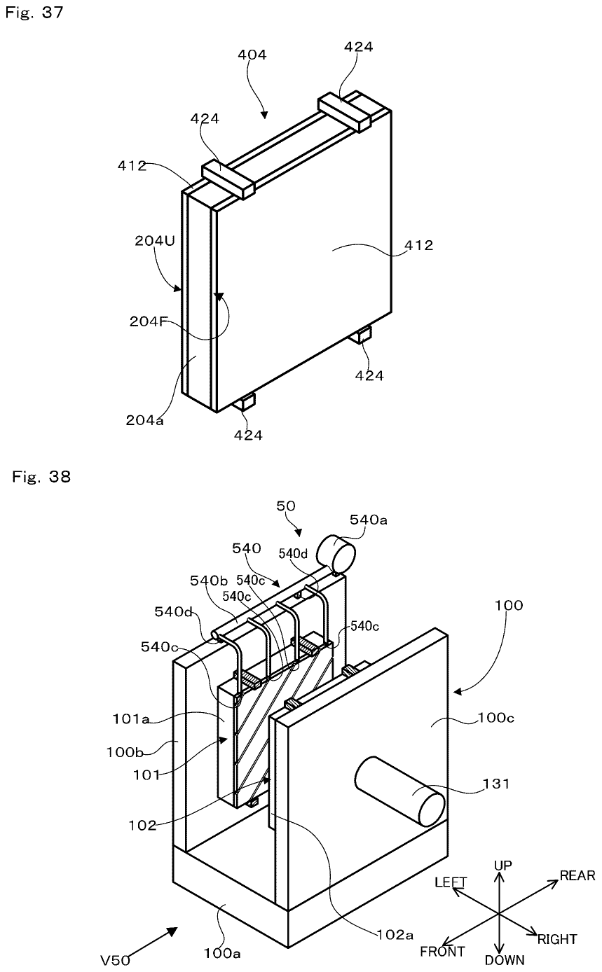

FIG. 37 is a perspective view of the high-temperature clamping member 404. As shown in FIG. 37, the high-temperature clamping member 404 includes the high-temperature heating plate 204a. A flat clamping plate 412 is detachably provided on the one surface 204U of the high-temperature heating plate 204a, and the flat clamping plate 412 is provided on the other surface 204F. The configuration and function of the flat clamping plate 412 are the same as those of the flat clamping plate 312 according to Embodiment 3. Note that a restricting member 424 of the high-temperature clamping member 404 is extended appropriately to match the thickness of the flat clamping plate 412.

As shown in FIGS. 35 and 36, the second clamping member 402 includes the second heating plate 202a. The flat clamping plate 412 is detachably attached to the front surface 202F of the second heating plate 202a. The configuration and function of the flat clamping plate 412 are the same as those of the flat clamping plate 312 according to Embodiment 3. Note that the restricting member 424 of the second clamping member 402 is extended appropriately to match the thickness of the flat clamping plate 412.

According to the present embodiment, the following effects are achieved. That is, due to the presence of the flat clamping plate 412 attached to both surfaces of the high-temperature clamping member 404, it is possible to prevent the accumulation of tar and the like on the surface of the high-temperature heating plate 204a. As a result, it is possible to further improve the maintainability of the high-temperature clamping member 404. In addition, due to the presence of the flat clamping plate 412 for the second clamping member 402, it is possible to prevent the accumulation of tar and the like on the second heating plate 202a. As a result, it is possible to further improve the maintainability of the second clamping member 402.

### Embodiment 5

Next, Embodiment 5 will be described. In the following description of Embodiment 5, elements that are the same as those in Embodiment 1 or have the same functions due to the same features are denoted by the same reference numerals, and the repeated description thereof will be omitted.

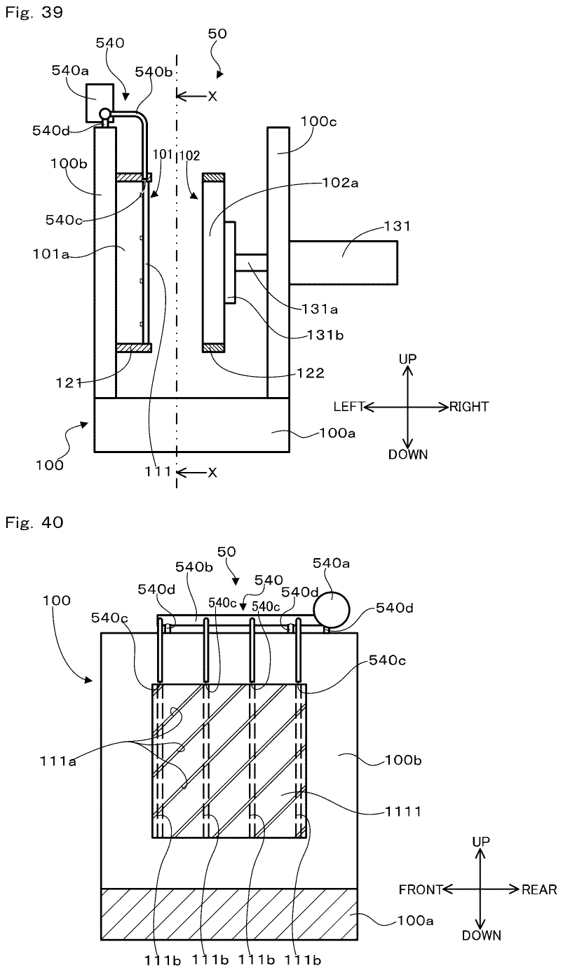

Embodiment 5 is a modification example of the dehydration apparatus 10 according to Embodiment 1. FIG. 38 is a perspective view of a dehydration apparatus 50 according to the present embodiment. FIG. 39 is a diagram of the dehydration apparatus 50 when viewed from the arrow V50 in FIG. 38. FIG. 40 is a cross-sectional view taken along the line X-X in FIG. 39. As is clear from a comparison between FIG. 3 and FIG. 38 and a comparison between FIG. 4 and FIG. 39, the dehydration apparatus 50 is different from the dehydration apparatus 10 according to Embodiment 1 in that the dehydration apparatus 50 includes a feeder 540.

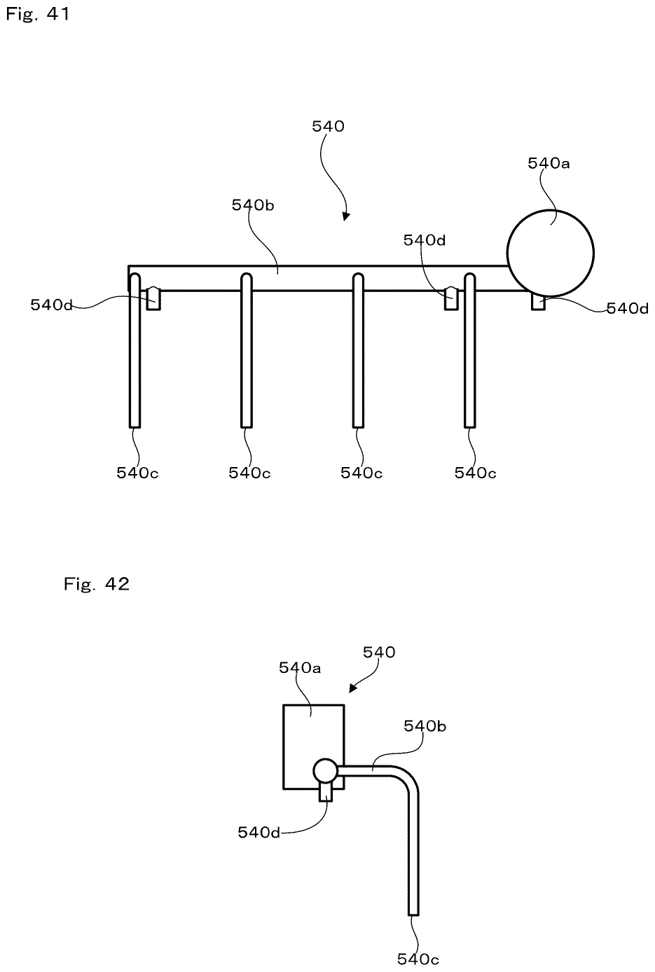

FIG. 41 is a diagram of the feeder 540 when viewed from right to left (a diagram corresponding to the feeder 540 shown in FIG. 40). FIG. 42 is a diagram of the feeder 540 when viewed from front to back (a diagram corresponding to the feeder 540 shown in FIG. 39). The feeder 540 is a device capable of blowing air from above into the interposed plate back groove 111b of the interposed plate 111 of the first clamping member 101 at a predetermined flow rate. As shown in FIGS. 38 to 42, the feeder 540 includes an air blower 540a such as a compressor, a blow passage 540b, and a plurality of air outlets 540c. As shown in FIG. 40, each of the air outlets 540c is arranged at a position facing the upper end of the interposed plate back groove 111b of the interposed plate 111. In addition, the feeder 540 includes a leg 540d that is fixed to the top surface of the support wall 100b to support the feeder 540 against the top surface of the support wall 100b.

The control unit 2a can control an air blower drive unit (not shown) for driving the air blower 540a. When the air blower drive unit drives the air blower 540a under the control of the control unit 2a, the air blower 540a blows out air. The air blown out by the air blower 540a reaches the plurality of air outlets 540c through the blow passage 540b, and is ejected from the air outlets 540c toward the upper end of the interposed plate back groove 111b of the interposed plate 111. The air ejected from the air outlet 540c enters the interposed plate back groove 111b through the upper end of the interposed plate back groove 111b.

In the present embodiment, during the period when the main dehydration process (step SA3 in FIG. 19) is being performed, the control unit 2a controls the air blower drive unit to drive the air blower 540a so that the air is ejected from each of the air outlets 540c. As a result, during the period when the raw veneer GV is being pressed in the main dehydration process, air with a flow rate is sent into each of the interposed plate back grooves 111b of the interposed plate 111. Then, by sending air with a flow rate into each of the interposed plate back grooves 111b of the interposed plate 111 to push out the treated water discharged from the raw veneer GV, the treated water can be discharged more quickly. In addition, since the flow rate inside the interposed plate back grooves 111b is higher than that of the outside air, negative pressure is obtained. Therefore, the treated water can be sucked from the interposed plate front groove 111a to the interposed plate back grooves 111b through the through hole ap1. This makes it difficult for the treated water to remain in each groove of the first heating plate 101a and the interposed plate 111, and accordingly, it is possible to effectively prevent tar and the like from adhering to and accumulating on the first heating plate 101a and the interposed plate 111.

Note that, in the present embodiment, the air blower 540a including a compressor and the like is attached to the frame 100. In this regard, a configuration may be adopted in which an air blower is provided outside the frame 100 so that air is blown out from the external air blower. In addition, as for the feeder 540, it does not matter whether the air outlet 540c and the interposed plate 111 are in contact with each other, as long as the feeder 540 is configured to be able to blow air into the interposed plate back groove 111b. In addition, depending on the configuration of the first clamping member 101, the leg 540d may not be provided. Alternatively, the blow passage 540b exposed to the outside may not be provided, but the blow passage may be formed inside the frame 100. The above also applies to Embodiment 6, which will be described later.

In addition, the feeder 540 (or an equivalent device) according to the present embodiment may be provided in the dehydration apparatus 50 according to Embodiment 3.

### Embodiment 6

Next, Embodiment 6 will be described. In the following description of Embodiment 6, elements that are the same as those in Embodiment 2 or have the same functions due to the same features are denoted by the same reference numerals, and the repeated description thereof will be omitted.

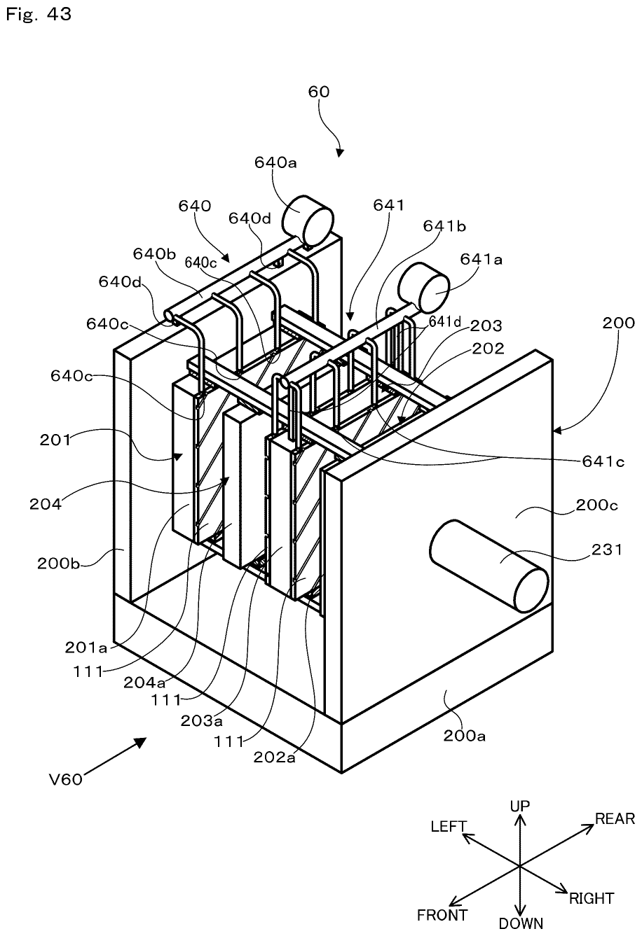

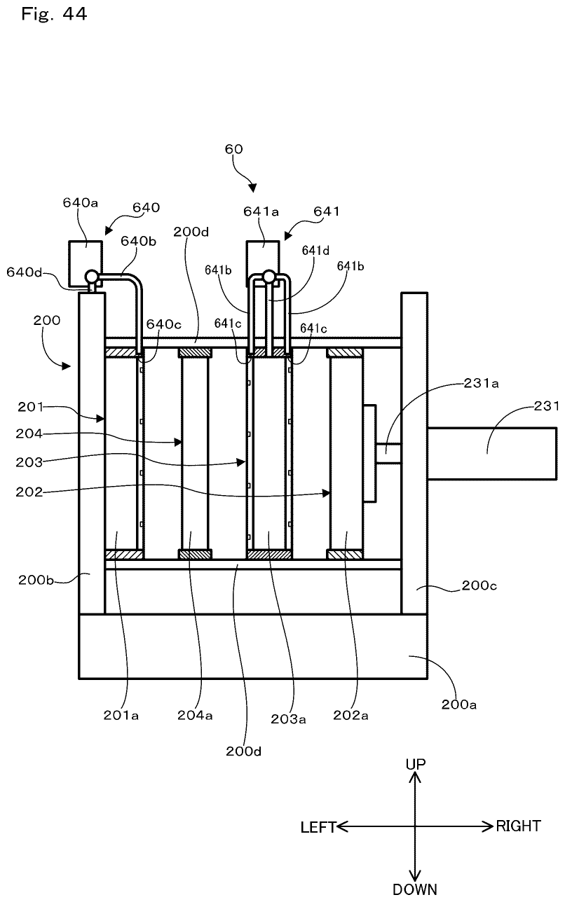

Embodiment 6 is a modification example of the dehydration apparatus 20 according to Embodiment 2. FIG. 43 is a perspective view of a dehydration apparatus 60 according to the present embodiment. FIG. 44 is a diagram of the dehydration apparatus 60 when viewed from the arrow V60 in FIG. 43. As is clear from a comparison between FIG. 21 and FIG. 43 and a comparison between FIG. 22 and FIG. 44, the dehydration apparatus 60 is different from the dehydration apparatus 20 according to Embodiment 2 in that the dehydration apparatus 60 includes a feeder 640 and a feeder 641.

As shown in FIGS. 43 and 44, the dehydration apparatus 60 includes the feeder 640 corresponding to the first clamping member 201. Since the configuration and function of the feeder 640 are the same as those of the feeder 540 according to the Embodiment 5, the feeder 640 will be briefly described. The feeder 640 includes an air blower 640a, a blow passage 640b, a plurality of air outlets 640c, and a leg 640d. Each of the air outlets 640c faces the upper end of each of the interposed plate back grooves 111b of the interposed plate 111. The feeder 640 has a function of blowing air into the interposed plate back groove 111b of the interposed plate 111 from above.

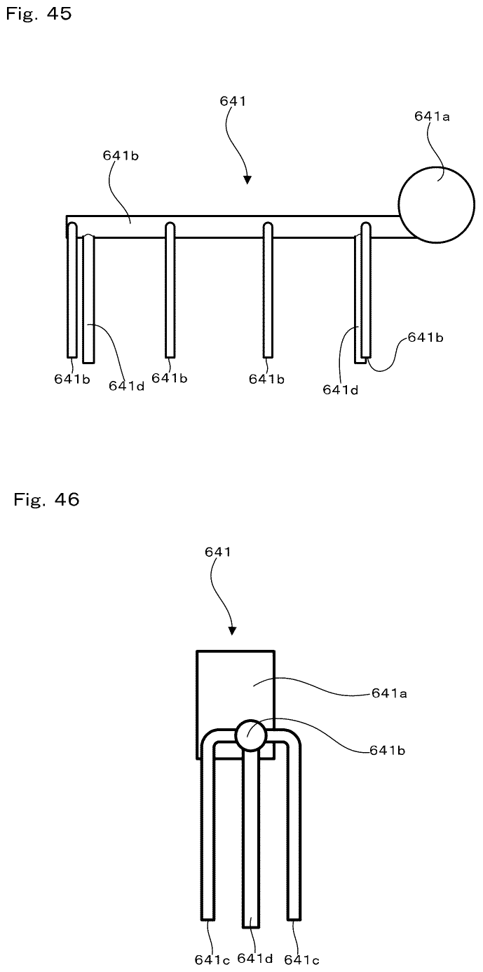

FIG. 45 is a diagram of the feeder 641 when viewed from right to left. FIG. 46 is a diagram of the feeder 641 when viewed from front to back (a diagram corresponding to the feeder 641 shown in FIG. 44). The feeder 641 is a device capable of blowing air from above into each of the interposed plate back groove 111b of the interposed plate 111 on the one surface 203U side of the low-temperature clamping member 203 and the interposed plate back groove 111b of the interposed plate 111 on the other surface 203F side at a predetermined flow rate. As shown in FIGS. 43 to 46, the feeder 641 includes an air blower 641a such as a compressor, a blow passage 641b, and a plurality of air outlets 641c. Four air outlets 641c of the plurality of air outlets 641c are arranged at positions facing the upper ends of the interposed plate back grooves 111b of the interposed plate 111 on the one surface 203U side of the low-temperature clamping member 203. In addition, four air outlets 641c of the plurality of air outlets 641c are arranged at positions facing the upper ends of the interposed plate back grooves 111b of the interposed plate 111 on the other surface 203F side of the low-temperature clamping member 203. In addition, the feeder 641 includes a leg 641d that is fixed to the top surface of the low-temperature heating plate 203a of the low-temperature clamping member 203 to support the feeder 641 against the top surface of the low-temperature heating plate 203a.

The control unit 2a can control an air blower drive unit (not shown) for driving the air blower 641a. When the air blower drive unit drives the air blower 641a under the control of the control unit 2a, the air blower 641a blows out air. The air blown out by the air blower 641a reaches the plurality of air outlets 641c through the blow passage 641b, and is ejected from the air outlets 641c toward the upper end of the interposed plate back groove 111b of the interposed plate 111. The air ejected from the air outlet 641c enters the interposed plate back groove 111b through the upper end of the interposed plate back groove 111b.

In the present embodiment, during the period when the main dehydration process (step SB3 in FIG. 31) is being performed, the control unit 2a controls the air blower drive unit to drive the air blower 641a so that the air is ejected from each of the air outlets 641c. As a result, for the same reason as explained in Embodiment 5, the treated water discharged from the second raw veneer GV2 and the third raw veneer GV3 can be quickly discharged. In addition, since the treated water is less likely to remain on the low-temperature heating plate 203a and the interposed plates 111 on both surfaces of the low-temperature heating plate 203a, it is possible to effectively prevent tar and the like from adhering to and accumulating on these members.

Note that the feeders 640 and 641 (or equivalent devices) according to the present embodiment may be provided in the dehydration apparatus 60 according to Embodiment 4.

Although the embodiments of the invention have been described above, each of the embodiments merely shows an example of specific implementation in carrying out the invention, and the technical scope of the invention should not be interpreted as being limited thereby. That is, the invention can be implemented in various forms without departing from the gist or main features thereof.

For example, in the dehydration apparatus 10 according to Embodiment 1, of the first clamping member 101 and the second clamping member 102 facing each other, the first clamping member 101 is fixed to the frame 100 and the second clamping member 102 is attached to and operated by the fluid cylinder 131, thereby bringing the clamping members closer to each other. In this regard, for example, another fluid cylinder 131 may be provided, the first clamping member 101 may be connected to the fluid cylinder 131, and the clamping members may be brought closer to each other by pressing the respective clamping members in directions toward each other. Alternatively, a separate cylinder or eccentric shaft may be used to bring the clamping members closer to each other. The above also applies to the drying apparatus 15, and also applies to a dehydration apparatus and a drying apparatus according to other embodiments.

In addition, in each embodiment, the interposed plate back groove 111b is formed on the back surface of the interposed plate 111. In this regard, the interposed plate back groove 111b may not be formed. Even in the case of this configuration, the same effects can be achieved even though the efficiency of discharging treated water or steam is lowered.

In addition, in each embodiment, for example, as shown in the overall views of FIGS. 3 and 4 in Embodiment 1, each heating plate in the dehydration apparatus and the drying apparatus is provided so as to stand approximately vertically. However, the angle of each heating plate does not have to be that angle. Any angle that allows the treated water or steam to be quickly discharged is possible. For example, the surface of the clamping member that clamps the raw veneer GV may be inclined at an angle of 45° with respect to the vertical direction. In addition, although the discharge efficiency is lowered, holes for discharge may be formed even if the heating plate is approximately horizontal, or it is possible to include a mechanism for actively discharging the treated water or steam, such as the feeder 540 in Embodiment 5.

In addition, in each embodiment, it is described that the clamping members are arranged in parallel and move in parallel. However, as long as the clamping surfaces are parallel to each other when clamping the veneer between the clamping members, any angle or any movement direction is possible. For example, the clamping members may be arranged so as to be movable in an approximately fan-like shape and opened and closed.

In addition, although the dehydration apparatus and the drying apparatus are separate in each embodiment, a configuration may also be adopted in which structures similar to both apparatuses are provided in a single housing.

In addition, in each embodiment, the pressing mechanism for pressing the clamping members is a fluid cylinder. In this regard, the pressing mechanism is not limited to the fluid cylinder. For example, the pressing mechanism may be configured to include a power transmission mechanism for transmitting the driving of the electric motor, or may be a mechanism for pressing the clamping members in response to the driving of the electric motor. That is, the pressing mechanism is a concept that includes all mechanisms having a function of pressing the clamping members under the control of the control unit.

In addition, the drive unit is not limited to the configuration exemplified in the present embodiment. That is, the drive unit is a concept that includes all the entities that drive the pressing mechanism under the control of the control unit. The drive unit is configured to include all elements necessary to drive the pressing mechanism under the control of the control unit, depending on the specific configuration of the pressing mechanism. Similarly, the heating unit is not limited to the configuration exemplified in the present embodiment. That is, the heating unit is a concept that includes all the entities that heat the heating plate under the control of the control unit. The heating unit is configured to include all elements necessary to heat the heating plate under the control of the control unit, depending on the specific configuration of the heating plate and the heating method.

In addition, in Embodiment 1, the control unit 2a of the single control apparatus 2 controls both the dehydration apparatus 10 and the drying apparatus 15. In this regard, a configuration may be adopted in which a control unit of one control apparatus controls the dehydration apparatus and a control unit of a control apparatus different from the one control apparatus controls the drying apparatus. In this case, the control unit of the one control apparatus and the control unit of the other control apparatus cooperate to function as a “control unit”. The above also applies to the other embodiments.

In addition, a part of the processing described in each embodiment as being performed by the control unit 2a may be configured to be performed by a control unit of an external apparatus other than the control apparatus 2. In this case, the control unit 2a of the control apparatus 2 and the control unit of the external apparatus cooperate to function as a “control unit”. An example of the external apparatus is a cloud server that can communicate with the control apparatus 2 through a network.

In addition, the embodiments may include providing a program executed by the computer of the control apparatus 2 or providing a recording medium on which the program is recorded so as to be readable by a computer. As the recording medium, a magnetic or optical recording medium or a semiconductor memory device can be used. Specifically, examples include portable or fixed recording media such as a flexible disks, an HDD (Hard Disk Drive), a CD-ROM (Compact Disk Read Only Memory), a DVD (Digital Versatile Disk), a Blu-ray (registered trademark) disc, a magneto-optical disk, a flash memory, and a card-type recording medium.

In addition, for example, in Embodiment 1, the configuration of the interposed plate 111 is specifically exemplified using the diagrams. However, the configuration of the interposed plate 111 in Embodiment 1 is merely a simplified example, and the configuration of the interposed plate 111 is not limited to the exemplified configuration. The configuration of the interposed plate 111 should be designed taking into consideration the ease of discharging the treated water discharged from the veneer V, the effort required to process the interposed plate 111, and the like. For example, the number of interposed plate front grooves 111a and the number of interposed plate back grooves 111b are not limited to the numbers exemplified. In addition, for example, the upper end portions of the interposed plate front groove 111a and the interposed plate back groove 111b do not have to reach the sides of the interposed plate 111. In addition, for example, the ratio between the size and the thickness of the surface of the interposed plate 111 is not limited to the ratio shown in the diagrams. The above also applies to the drying side interposed plate 161 and other embodiments.

In addition, in Embodiment 2, in the dehydration apparatus 20, a guide groove is formed in the four rails 200d, and the restricting member of each clamping member is fitted into the guide groove. However, the configuration of the rail 200d and the mechanism by which each clamping member is supported on the rail 200d are not limited to the contents exemplified in Embodiment 2. For example, no guide groove may be formed in the rail 200d, and each restricting member may come into contact with the surface of the rail 200d, thereby supporting the clamping members on the rail 200d. That is, the rail 200d may have any configuration as long as it is possible to support each clamping member. The above also applies to the drying apparatus 25.

### REFERENCE SIGNS LIST

1, 1-2: veneer processing system
1a, 1a-2: dehydration system
2a: control unit
3: Heating unit
4: drive unit
5: drying side heating unit
6: drying side drive unit
10, 20, 30, 40, 50, 60: dehydration apparatus
101, 201: first clamping member
101a, 201a: first heating plate
102, 202, 402: second clamping member
102a, 202a: second heating plate
111: interposed plate
111a: interposed plate front groove (groove)
111b: interposed plate back groove (groove)
ap1: through hole
131, 231: fluid cylinder (pressing mechanism)
15, 25: drying apparatus
151, 251: first drying side clamping member
151a, 251a: first drying side heating plate
152, 252: second drying side clamping member
152a, 252a: second drying side heating plate
161: drying side interposed plate
161a: drying side interposed plate front groove (groove)
161b: drying side interposed plate back groove (groove)
181, 281: drying side fluid cylinder (pressing mechanism)
540, 640, 641: feeder

1. A veneer processing system, comprising:
a dehydration system for performing a dehydration process on a veneer before a drying process,
wherein the dehydration system includes:
a first clamping member including a first heating plate that is a heating plate capable of generating heat;
a second clamping member including a second heating plate that is a heating plate capable of generating heat;
a drive unit capable of causing a pressing mechanism to press at least one of the first clamping member and the second clamping member;
a heating unit capable of heating the first heating plate and the second heating plate; and
a control unit that, during the dehydration process, controls the drive unit so that the veneer is pressed by the first clamping member and the second clamping member and controls the heating unit so that a temperature of the first heating plate is lower than a temperature of the second heating plate,
the first clamping member and the second clamping member have surfaces extending parallel to an up-down direction and are capable of pressing the veneer in a state in which a surface of the veneer is parallel to the up-down direction.
the first clamping member includes an interposed plate that is attached to the first heating plate and that is interposed between the first heating plate and the veneer during the dehydration process, and
a plurality of oblique grooves extending obliquely with respect to the up-down direction are formed on one surface of the interposed plate in contact with the veneer.

3. The veneer processing system according to claim 1,
wherein a plurality of vertical grooves extending in the up-down direction are formed on the other surface that is a surface of the interposed plate on a side opposite to the one surface on which the oblique grooves are formed and is in contact with the first heating plate, and
in the interposed plate, a through hole penetrating the interposed plate in a thickness direction is formed at points where the oblique grooves formed on the one surface cross the vertical grooves formed on the other surface.

4. The veneer processing system according to claim 3, further comprising:
a feeder capable of blowing air from above into the vertical grooves formed on the other surface of the interposed plate.

5. The veneer processing system according to claim 1,
wherein the control unit controls the heating unit so that, during the dehydration process, the temperature of the second heating plate becomes a temperature close to a temperature at which evaporation of moisture from the veneer due to heat generated by the second heating plate starts and the temperature of the first heating plate becomes a temperature at which evaporation of moisture from the veneer due to heat generated by the first heating plate does not occur.

6. The veneer processing system according to claim 1, further comprising:
a drying system for performing a drying process on a veneer subjected to a dehydration process by the dehydration system,
wherein the drying system includes:
a first drying side clamping member including a first drying side heating plate that is a heating plate capable of generating heat;
a second drying side clamping member including a second drying side heating plate that is a heating plate capable of generating heat;
a drying side drive unit capable of causing a pressing mechanism to press at least one of the first drying side clamping member and the second drying side clamping member; and
a drying side heating unit capable of heating the first drying side heating plate and the second drying side heating plate, and
during the drying process, the control unit controls the drying side drive unit so that the veneer is held by the first drying side clamping member and the second drying side clamping member and controls the drying side heating unit so that a temperature of the first drying side heating plate is lower than a temperature of the second drying side heating plate.

7. The veneer processing system according to claim 6,
wherein the first drying side clamping member includes a first drying side interposed plate that is attached to the first drying side heating plate and that is interposed between the first drying side heating plate and the veneer during the drying process,
a plurality of grooves extending in a direction crossing the up-down direction are formed on one surface of the first drying side interposed plate in contact with the veneer,
the second drying side clamping member includes a second drying side interposed plate that is attached to the second drying side heating plate and that is interposed between the second drying side heating plate and the veneer during the drying process, and
a plurality of grooves extending in a direction crossing the up-down direction are formed on one surface of the second drying side interposed plate in contact with the veneer.

8. The veneer processing system according to claim 7,
wherein a plurality of grooves extending in the up-down direction are formed on the other surface of the first drying side interposed plate in contact with the first drying side heating plate,
in the first drying side interposed plate, a through hole penetrating the first drying side interposed plate in a thickness direction is formed at points where the grooves formed on the one surface and extending in the direction crossing the up-down direction cross the grooves formed on the other surface and extending in the up-down direction,
a plurality of grooves extending in the up-down direction are formed on the other surface of the second drying side interposed plate in contact with the second drying side heating plate, and
in the second drying side interposed plate, a through hole penetrating the second drying side interposed plate is formed at points where the grooves formed on the one surface and extending in the direction crossing the up-down direction cross the grooves formed on the other surface and extending in the up-down direction.

9. A method for dehydrating a veneer using a dehydration system including a first clamping member including a first heating plate that is a heating plate capable of generating heat, a second clamping member including a second heating plate that is a heating plate capable of generating heat, a drive unit capable of causing a pressing mechanism to press at least one of the first clamping member and the second clamping member, and a heating unit capable of heating the first heating plate and the second heating plate, the veneer dehydration method comprising:
a step in which a control unit controls the drive unit so that the veneer is held by the first clamping member and the second clamping member; and
a step in which the control unit controls the drive unit so that the veneer is pressed by the first clamping member and the second clamping member and controls the heating unit so that a temperature of the first heating plate is lower than a temperature of the second heating plate,
wherein the first clamping member and the second clamping member have surfaces extending parallel to an up-down direction and are capable of pressing the veneer in a state in which a surface of the veneer is parallel to the up-down direction,
the first clamping member includes an interposed plate that is attached to the first heating plate and that is interposed between the first heating plate and the veneer during the dehydration process, and
a plurality of oblique grooves extending obliquely with respect to the up-down direction are formed on one surface of the interposed plate in contact with the veneer.

10. A method for processing a veneer using a veneer processing system including a dehydration system including a first clamping member including a first heating plate that is a heating plate capable of generating heat, a second clamping member including a second heating plate that is a heating plate capable of generating heat, a drive unit capable of causing a pressing mechanism to press at least one of the first clamping member and the second clamping member, and a heating unit capable of heating the first heating plate and the second heating plate and a drying system including a first drying side clamping member including a first drying side heating plate that is a heating plate capable of generating heat, a second drying side clamping member including a second drying side heating plate that is a heating plate capable of generating heat, a drying side drive unit capable of causing a pressing mechanism to press at least one of the first drying side clamping member and the second drying side clamping member, and a drying side heating unit capable of heating the first drying side heating plate and the second drying side heating plate, the veneer processing method comprising:
a step in which a control unit controls the drive unit so that the veneer is pressed by the first clamping member and the second clamping member of the dehydration system and controls the heating unit so that a temperature of the first heating plate is lower than a temperature of the second heating plate; and
a step in which the control unit controls the drying side drive unit so that the veneer is held by the first drying side clamping member and the second drying side clamping member of the drying system and controls the drying side heating unit so that a temperature of the first drying side heating plate is lower than a temperature of the second drying side heating plate,
wherein the first clamping member and the second clamping member have surfaces extending parallel to an up-down direction and are capable of pressing the veneer in a state in which a surface of the veneer is parallel to the up-down direction,
the first clamping member includes an interposed plate that is attached to the first heating plate and that is interposed between the first heating plate and the veneer during the dehydration process, and
a plurality of oblique grooves extending obliquely with respect to the up-down direction are formed on one surface of the interposed plate in contact with the veneer.

11. The veneer processing system according to claim 3,
wherein a width of the vertical groove in the interposed plate is larger than a width of the oblique groove.
